(19) United States
(12) Patent Application Publication
(10) Pub. No.: US 2026/0138463 A1
(43) Pub. Date: May 21, 2026

(54) WORKING VEHICLE

(71) Applicant: Kubota Corporation, Osaka-shi (JP)

(72) Inventor: Shotaro KAWAHATA, Fremont, CA (US)

(21) Appl. No.: 19/380,092

(22) Filed: Nov. 5, 2025

Related U.S. Application Data
(60) Provisional application No. 63/722,693, filed on Nov. 20, 2024.

(51) Int. Cl. B60L 15/20; A01B 76/00; B60K 1/02

(52) U.S. Cl. CPC B60L 15/2009; A01B 76/00; B60K 1/02; B60L 2200/40; B60L 2220/42; B60L 2240/26; B60L 2240/441

(57) ABSTRACT

A working vehicle includes a travel vehicle body, a power system including one or more electric motors to drive one or more wheels at a left side of the travel vehicle body and one or more wheels at a right side of the travel vehicle body, a braking actuator, a one-side braking command actuator, a steering system to steer the travel vehicle body based on an operation of a steering actuator, and a travel controller. The travel controller is configured or programmed to, when the one-side braking command actuator is operated, control, based on whether the braking actuator is being operated, one or more of the electric motor(s) that correspond to inner wheel(s) that are the one or more wheels at an inner side of a turn made by the travel vehicle body steered by the steering actuator to stop or reduce a rotation speed of the inner wheel(s).

### CROSS REFERENCE TO RELATED APPLICATIONS

This application claims the benefit of priority to U.S. Provisional Ser. No. 63/722,693 filed on Nov. 20, 2024. The entire contents of this application are hereby incorporated herein by reference.

### BACKGROUND OF THE INVENTION

### 1. Field of the Invention

The present invention relates to working vehicles, such as electric tractors, in which wheels are driven by electric motors.

### 2. Description of the Related Art

Japanese U.S. Pat. No. 7,361,461 discloses a tractor driving system in a working vehicle equipped with a two-piece brake pedal to brake left and right wheels independently of each other. The tractor driving system detects operational statuses of a right brake pedal and a left brake pedal and performs control for all-wheel drive and for enabling and disabling a locking differential.

### SUMMARY OF THE INVENTION

The tractor driving system in Japanese U.S. Pat. No. 7,361,461 is configured to drive the wheels by using a driving source based on an internal combustion engine (engine), but is not configured to drive the wheels by using an electric motor, and thus cannot properly control the rotation speed of the electric motor for the left and right wheels in response to a braking operation performed by a user. Because the driving system in Japanese U.S. Pat. No. 7,361,461 employs the two-piece brake pedal, if the two-piece brake pedal is changed to a single brake pedal, determination of whether or not one-side braking is to be performed is not possible, and proper execution of one-side braking is not possible.

Example embodiments of the present invention provide working vehicles each of which can properly determine whether or not one-side braking is to be performed and can properly perform one-side braking.

A working vehicle according to an example embodiment of the present invention includes a travel vehicle body, a power system including one or more electric motors to drive one or more wheels at a left side of the travel vehicle body and one or more wheels at a right side of the travel vehicle body, a braking actuator, a one-side braking command actuator, a steering system to steer the travel vehicle body based on an operation of a steering actuator, and a travel controller, wherein the travel controller is configured or programmed to, when the one-side braking command actuator is operated, control, based on whether or not the braking actuator is being operated, one or more of the one or more electric motors that correspond to one or more inner wheels that are the one or more wheels at an inner side of a turn made by the travel vehicle body steered by the steering actuator to stop or reduce a rotation speed of the one or more inner wheels.

The travel controller may be configured or programmed to, when the one-side braking command actuator is operated, perform control to stop or reduce the rotation speed of the one or more inner wheels when the braking actuator is being operated, and not perform the control to stop or reduce the rotation speed of the one or more inner wheels when the braking actuator is not being operated.

The travel controller may be configured or programmed to, when the one-side braking command actuator is operated, reduce the rotation speed of the one or more inner wheels to a rotation speed corresponding to a first reduction rate when the braking actuator is being operated, and reduce the rotation speed of the one or more inner wheels to a rotation speed corresponding to a second reduction rate smaller than the first reduction rate when the braking actuator is not being operated.

The travel controller may be configured or programmed to, when the one-side braking command actuator is operated, control the rotation speed of the one or more inner wheels at zero or a negative value when an operation amount of the braking actuator is equal to or greater than a predetermined value.

The travel controller may be configured or programmed to, when the one-side braking command actuator is operated, control the rotation speed of the one or more inner wheels at a zero or a negative value when the following condition is satisfied: the operation amount of the braking actuator is equal to or greater than the predetermined value; and a speed of the travel vehicle body is equal to or less than a predetermined speed.

The travel controller may be configured or programmed to prohibit control of the rotation speed of the one or more inner wheels at zero or a negative value in a case that a working device connected to the travel vehicle body is a towed working device.

The travel controller may be configured or programmed to control the rotation speed of the one or more inner wheels at zero or a negative value in a case that a weight of a working device connected to the travel vehicle body is equal to or less than a predetermined weight.

The travel controller may be configured or programmed to control the rotation speed of the one or more inner wheels at zero or a negative value in a case that a tilt angle of the travel vehicle body is equal to or less than a predetermined tilt angle.

The travel controller may be configured or programmed to, when the one-side braking command actuator is operated, reduce the rotation speed of the one or more inner wheels to a rotation speed corresponding to a first reduction rate in a case that the braking actuator is being operated and no working devices are connected to the travel vehicle body, and reduce the rotation speed of the one or more inner wheels to a rotation speed corresponding to a second reduction rate smaller than the first reduction rate in a case that a working device is connected to the travel vehicle body.

The travel controller may be configured or programmed to, when the one-side braking command actuator is operated, reduce the rotation speed of the one or more inner wheels to a rotation speed corresponding to a first reduction rate in a case that the braking actuator is being operated and a working device connected to the travel vehicle body is a directly attached working device, and reduce the rotation speed of the one or more inner wheels to a rotation speed corresponding to a second reduction rate smaller than the first reduction rate in a case that the working device is a towed working device.

The travel controller may be configured or programmed to, when the one-side braking command actuator is operated, control one of the one or more electric motors that corresponds to a front one of the one or more inner wheels to stop or reduce the rotation speed of the front one of the one or more inner wheels in a case that the braking actuator is being operated and a working device is connected to a front portion of the travel vehicle body, and control one of the one or more electric motors that corresponds to a rear one of the one or more inner wheels to stop or reduce the rotation speed of the rear one of the one or more inner wheels in a case that the working device is connected to a rear portion of the travel vehicle body or no working devices are connected to the travel vehicle body.

The travel controller may be configured or programmed to, in a case that the working device is connected to the front portion of the travel vehicle body, reduce the rotation speed of the front one of the one or more inner wheels to a rotation speed corresponding to a first reduction rate, and reduce the rotation speed of the rear one of the one or more inner wheels to a rotation speed corresponding to a second reduction rate smaller than the first reduction rate.

The travel controller may be configured or programmed to, in a case that the working device is connected to the rear portion of the travel vehicle body or no working devices are connected to the travel vehicle body, reduce the rotation speed of the rear one of the one or more inner wheels to a rotation speed corresponding to a first reduction rate, and reduce the rotation speed of the front one of the one or more inner wheels to a rotation speed corresponding to a second reduction rate smaller than the first reduction rate.

The braking actuator may be a single actuator.

A working vehicle according to another example embodiment includes a travel vehicle body, a power system including one or more electric motors to drive one or more wheels at a left side of the travel vehicle body and one or more wheels at a right side of the travel vehicle body, a steering system to steer the travel vehicle body based on an operation of a steering actuator, an input interface to receive an input of an operation to stop or reduce a rotation speed of one or more inner wheels that are the one or more wheels at an inner side of a turn made by the travel vehicle body steered by the steering actuator, and a travel controller, wherein the travel controller is configured or programmed to, when the input interface receives input of the operation while the one or more wheels at the left side and the one or more wheels at the right side are both receiving a braking force applied by braking operation, control one or more of the one or more electric motors that correspond to the one or more inner wheels to stop or reduce the rotation speed of the one or more inner wheels.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 illustrates an example of a system of a working vehicle.

FIG. 2 illustrates an example of devices and units related to travel by a traveling device.

FIG. 3 is a side view schematically illustrating an example of the working vehicle.

FIG. 4 is a plan view schematically illustrating the example of the working vehicle.

FIG. 5 is a side view schematically illustrating another example of the working vehicle.

FIG. 6 illustrates an operator's seat and the vicinity thereof.

FIG. 7 is a perspective view of a raising/lowering device as viewed from the rear.

FIG. 8 illustrates another example of the devices and units related to travel by the traveling device.

FIG. 9A illustrates a travel controller, peripheral devices, and the like of the working vehicle.

FIG. 9B illustrates that the travel controller controls electric motors and braking mechanisms.

FIG. 10A is a flowchart illustrating a first example of a travel control process performed by the travel controller.

FIG. 10B is a flowchart illustrating a second example of the travel control process performed by the travel controller.

FIG. 10C is a flowchart illustrating a third example of the travel control process performed by the travel controller.

FIG. 10D is a flowchart illustrating a fourth example of the travel control process performed by the travel controller.

FIG. 10E is a flowchart illustrating a fifth example of the travel control process performed by the travel controller.

FIG. 10F is a flowchart illustrating a sixth example of the travel control process performed by the travel controller.

FIG. 10G is a flowchart illustrating a seventh example of the travel control process performed by the travel controller.

FIG. 10H is a flowchart illustrating an eighth example of the travel control process performed by the travel controller.

FIG. 10I is a flowchart illustrating a ninth example of the travel control process performed by the travel controller.

FIG. 10J is a flowchart illustrating a tenth example of the travel control process performed by the travel controller.

FIG. 10K is a flowchart illustrating an eleventh example of the travel control process performed by the travel controller.

FIG. 11 illustrates a first determination table.

FIG. 12 illustrates a second determination table.

FIG. 13 illustrates a third determination table.

FIG. 14 illustrates a fourth determination table.

FIG. 15 illustrates a fifth determination table.

FIG. 16 illustrates a sixth determination table.

FIG. 17 is a plan view schematically illustrating rear-wheel one-side braking and front-wheel one-side braking.

FIG. 18 illustrates a seventh determination table.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

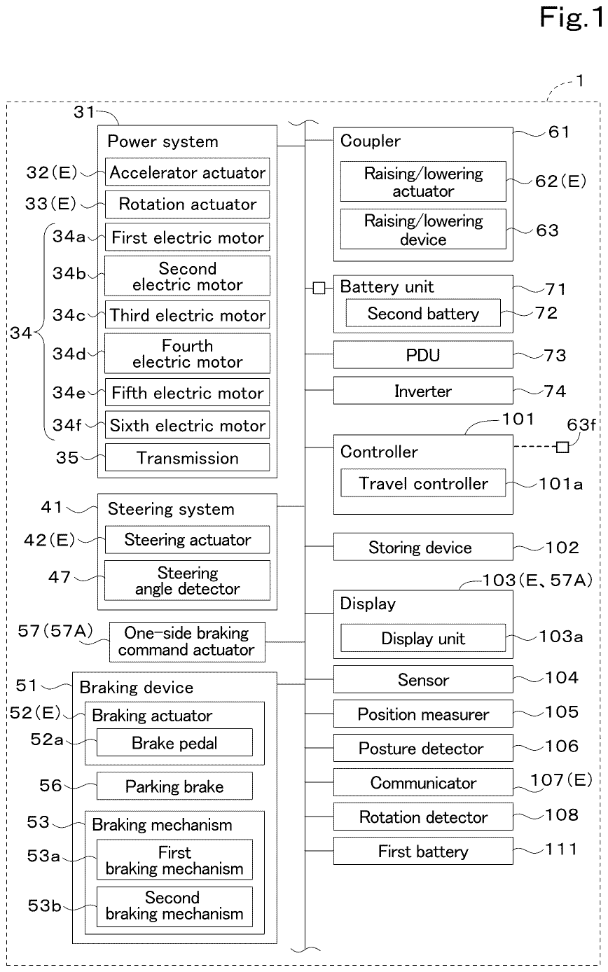

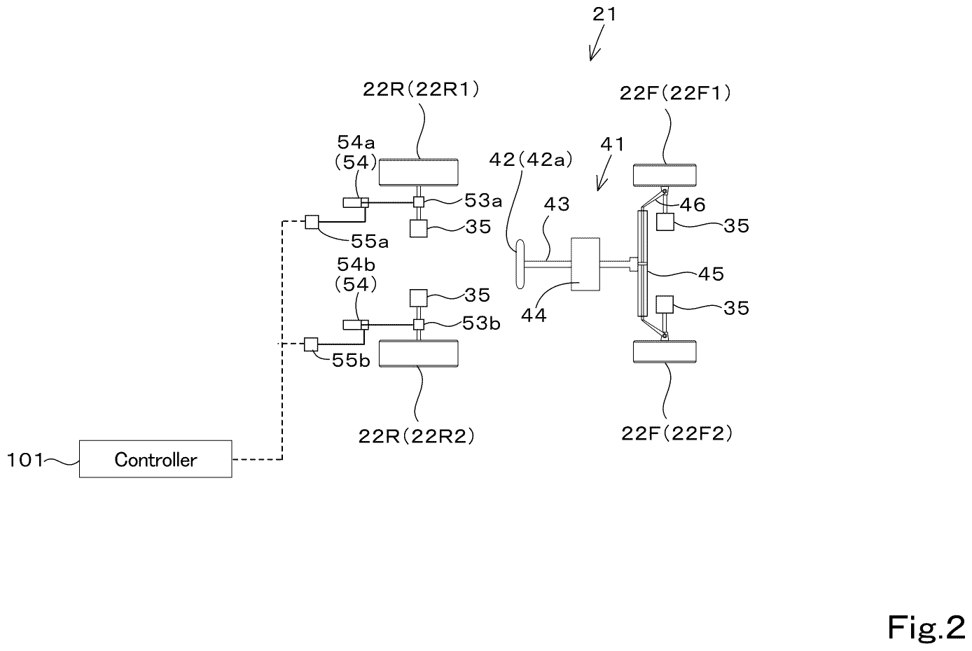

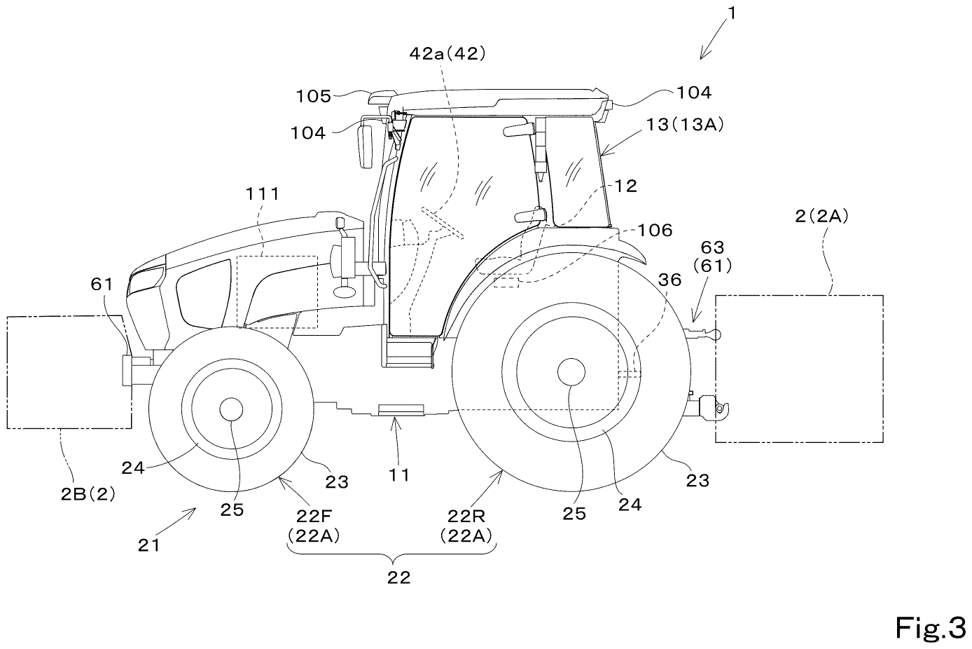

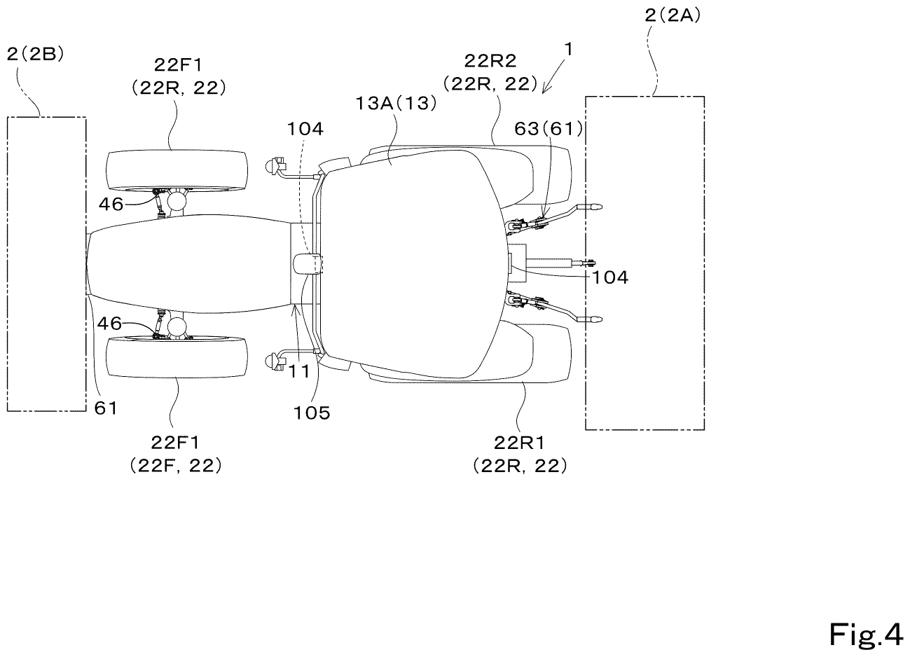

Example embodiments of the present invention will be described below with reference to the drawings. FIG. 1 illustrates an example of a system of a working vehicle 1. FIG. 2 illustrates an example of devices and units related to travel by a traveling device 21. FIG. 3 is a side view schematically illustrating an example of the working vehicle 1. FIG. 4 is a plan view schematically illustrating the example of the working vehicle 1. The working vehicle 1 is a vehicle capable of traveling in accordance with the traveling device 21. In the present example embodiment, the working vehicle 1 is a tractor having a travel vehicle body 11 (machine body) to which at least one working device 2 (implement) is attachable. The working vehicle 1 will be described below by focusing on a tractor that operates by being manually operated by an operator sitting in an operator's seat 12.

Although a detailed description will be omitted, the working vehicle 1 may operate based on autonomous driving control not dependent on a manual operation by the operator, or may operate based on remote driving control dependent on a manual operation performed using a remote controller at a remote location. The working vehicle 1 is not limited to a tractor so long as the working vehicle 1 is a vehicle capable of traveling in accordance with the traveling device 21 and allows the working device 2 to be attachable to and detachable from the vehicle. For example, the working vehicle 1 may be a construction working machine, such as a compact track loader or backhoe to and from which a working device (attachment) is attachable and detachable.

In the following description, a direction in which the operator sitting in the operator's seat 12 of the working vehicle 1 faces (toward the left in FIG. 3 and FIG. 4) will be referred to as a forward direction, and a direction opposite therefrom (toward the right in FIG. 3 and FIG. 4) will be referred to as a rearward direction. A direction extending leftward from the operator (toward the viewer of FIG. 3 and downward in FIG. 4) will be referred to as a leftward direction, and a direction extending rightward from the operator (away from the viewer of FIG. 3 and upward in FIG. 4) will be referred to as a rightward direction. A horizontal direction as a direction orthogonal to the front-rear direction will be referred to as a width direction. A direction orthogonal to the horizontal direction will be referred to as an up-down direction.

As illustrated in FIG. 3 and FIG. 4, the working vehicle 1 includes the travel vehicle body 11 and the traveling device 21. The travel vehicle body 11 supports various devices and units included in the working vehicle 1. For example, the travel vehicle body 11 is provided with the operator's seat 12 and a protection mechanism 13 for protecting the operator's seat 12. The protection mechanism 13 is, for example, a cabin 13A that surrounds the operator's seat 12. The protection mechanism 13 is not limited to the cabin 13A and may be a canopy or a rollover protection structure (ROPS) standing upright behind the operator's seat 12.

The traveling device 21 is a device that supports the travel vehicle body 11 in a travelable manner. The traveling device 21 applies a propelling force to the travel vehicle body 11 by being driven. The traveling device 21 includes one or more wheels 22 that rotate in accordance with power supplied from a power system 31. In the present example embodiment, the traveling device 21 includes multiple wheels 22. The multiple wheels 22 are arranged apart from one another in the front-rear direction or the width direction. The traveling device 21 includes a pair of front wheels 22F that support a front portion of the travel vehicle body 11, and a pair of rear wheels 22R that support a rear portion of the travel vehicle body 11. The outer diameter of the rear wheels 22R is larger than the outer diameter of the front wheels 22F in the example illustrated in FIG. 3 and FIG. 4, but may be set substantially equal to the outer diameter of the front wheels 22F.

In detail, a left front wheel 22F1 as the left one of the front wheels 22F and a right front wheel 22F2 as the right one of the front wheels 22F are arranged apart from each other in the width direction of the travel vehicle body 11. A left rear wheel 22R1 as the left one of the rear wheels 22R and a right rear wheel 22R2 as the right one of the rear wheels 22R are arranged apart from each other in the width direction of the travel vehicle body 11. The left front wheel 22F1 and the left rear wheel 22R1 are arranged apart from each other in the front-rear direction of the travel vehicle body 11. The right front wheel 22F2 and the right rear wheel 22R2 are arranged apart from each other in the front-rear direction of the travel vehicle body 11.

In the example illustrated in FIG. 3 and FIG. 4, the multiple wheels 22 included in the traveling device 21 are wheeled-vehicle-type wheels 22A that include tires 23. Each wheeled-vehicle-type wheel 22A includes a tire 23, a ring-shaped rim 24 with the tire 23 fitted around the outer periphery thereof, and a hub 25 that is located at the center of the tire 23 and with which the rim 24 is attached to an axle.

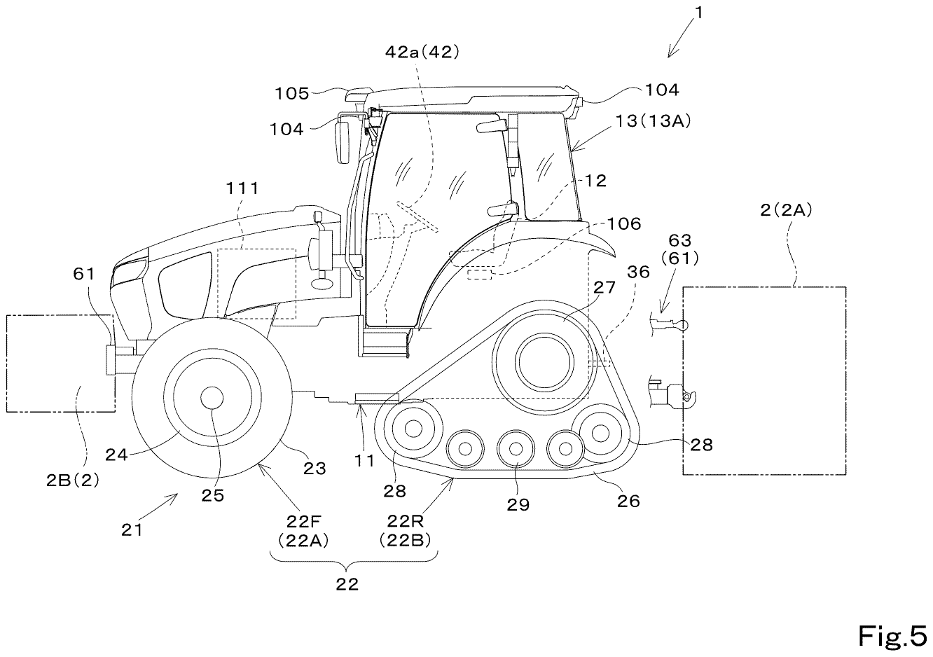

The multiple wheels 22 are not limited to the wheeled-vehicle-type wheels 22A, and may include crawler-type wheels 22B (continuous tracks), as illustrated in FIG. 5. FIG. 5 is a side view schematically illustrating another type of working vehicle 1. Each crawler-type wheel 22B includes a crawler 26, a driving wheel 27 that drives the crawler 26 in a cyclic manner, and a driven wheel 28 that rotates together with the cyclic driving of the crawler 26. The crawler 26 is, for example, a rubber crawler formed of rubber as an elastic body. In addition to the crawler 26, the driving wheel 27, and the driven wheel 28, the crawler-type wheel 22B may include multiple rolling wheels (idler wheels) 29.

Of the multiple wheels 22, at least each pair of wheels 22 in the width direction preferably have the same configuration, whereas the front wheels 22F and the rear wheels 22R may have different configurations. Specifically, the front wheels 22F may be the wheeled-vehicle-type wheels 22A, and the rear wheels 22R may be the crawler-type wheels 22B, as in the variation illustrated in FIG. 5, or the multiple wheels 22 may all be the crawler-type wheels 22B. It is also possible to use a configuration where the traveling device 21 does not include both the front wheels 22F and the rear wheels 22R, that is, a total of four wheels 22, but only includes a pair in the width direction, that is, a total of two crawler-type wheels 22B. The following description focuses on a case where all of the multiple wheels 22 are wheeled-vehicle-type wheels 22A, as illustrated in FIG. 3 and FIG. 4.

The power system 31 supplies power to the traveling device 21. As illustrated in FIG. 1, the power system 31 includes, for example, at least one electric motor 34, and drives the traveling device 21 in accordance with power (rotational driving force) generated by the at least one electric motor 34. Specifically, the working vehicle 1 is an electric working vehicle driven by the electric motor 34. The electric motor 34 is an interior permanent magnet alternating current synchronous motor, a wound field synchronous motor, or the like. The electric motor 34 is driven by electric power supplied from a first battery 111 (main battery) provided in the travel vehicle body 11. The first battery 111 is capable of storing electricity and is, for example, a secondary battery, such as a lithium ion battery or a lead acid battery. The first battery 111 includes multiple cells therein. The multiple cells are electrically connected in series and in parallel. A power supply path that connects the first battery 111 and the electric motor 34 is provided with a power distribution unit (PDU) 73 and multiple (four) inverters 74. The PDU 73 is a power distribution unit that distributively supplies the electric power from the first battery 111 to the four inverters 74. The inverters 74 are devices that drive the electric motor 34, convert direct-current power into three-phase alternating-current power, and supply the three-phase alternating-current power to the electric motor 34. The inverters 74 are capable of arbitrarily changing the electric current and voltage of the electric power to be supplied to the electric motor 34.

In the present example embodiment, the power system 31 includes multiple electric motors 34 that supply power to the respective wheels 22 included in the traveling device 21. In other words, the power system 31 includes the multiple electric motors 34 corresponding to the respective wheels 22, such that each wheel 22 is independently driven by the corresponding electric motor 34. The multiple electric motors 34 include a first electric motor 34a that drives the left front wheel 22F1, a second electric motor 34 b that drives the right front wheel 22F2, a third electric motor 34c that drives the left rear wheel 22R1, and a fourth electric motor 34d that drives the right rear wheel 22R2. At least the first electric motor 34 a to the fourth electric motor 34d are capable of rotating in the forward direction and the reverse direction.

The power system 31 may supply power to a device different from the traveling device 21. In the present example embodiment, in addition to the multiple electric motors 34 that drive the traveling device 21, the power system 31 includes a fifth electric motor 34e to drive a power take-off (PTO) shaft 36 that supplies power to the working device 2, and a sixth electric motor 34f to drive a hydraulic pump that actuates a hydraulic unit provided in the working vehicle 1. In the present example embodiment, the PTO shaft 36 is provided to protrude rearward from the rear portion of the travel vehicle body 11. The PTO shaft 36 may be provided to protrude forward from the front portion of the travel vehicle body 11. The PTO shaft 36 is provided in at least one of the front portion and the rear portion of the travel vehicle body 11.

Although the working vehicle 1 will be described below with reference to an example where the power system 31 includes the multiple electric motors 34 that supply power to the respective wheels 22, the power system 31 may include a common electric motor 34 that supplies power to the multiple wheels 22. In that case, the multiple wheels 22 are driven by power supplied from the common electric motor 34. Moreover, the electric motor 34 may supply power to another device (such as the PTO shaft 36 and the hydraulic pump) in addition to the multiple wheels 22. The number of electric motors 34 included in the power system 31 and the power supply destinations (such as the wheels 22 and the PTO shaft 36) are not limited to those in the above example.

An output shaft of the electric motor 34 is directly or indirectly connected to an input shaft of each power supply destination, and transmits the generated power to the supply destination. The output shaft of the electric motor 34 is indirectly connected to the input shaft of the supply destination via, for example, a transmission 35 including multiple gears.

As illustrated in FIG. 1 and FIG. 2, the working vehicle 1 includes a steering system 41. The steering system 41 changes a steering direction and a steering angle (rudder angle) of the working vehicle 1. The steering system 41 includes a steering actuator 42, a steering shaft 43, a steering control valve 44, a steering cylinder 45, an arm 46 (knuckle arm), and a steering angle detector 47.

The steering actuator 42 includes a steering handle 42a (steering wheel). The steering handle 42a is provided in the vicinity of the operator's seat 12 and is operated by the operator sitting in the operator's seat 12.

The steering shaft 43 is a rotation shaft that rotatably supports the steering handle 42a.

The steering control valve 44 is supplied with a hydraulic fluid delivered from the hydraulic pump and adjusts the hydraulic fluid toward the steering cylinder 45. The steering control valve 44 is, for example, a three-position switching valve switchable by moving a spool or the like, and is switched in accordance with the steering direction (rotational direction) of the steering shaft 43.

The steering cylinder 45 is driven by the hydraulic fluid supplied from the steering control valve 44. When the switch position and the opening of the steering control valve 44 change, the steering cylinder 45 extends and retracts toward one side or the other side in the width direction in accordance with the switch position and the opening of the steering control valve 44.

The arm 46 is connected to the steering cylinder 45 and moves in accordance with the extension and retraction of the steering cylinder 45, thus changing the steering (the steering direction and the rudder angle) of the front wheels 22F.

The steering angle detector 47 detects a steering operation (the steering direction and the rudder angle) of the steering actuator 42, and outputs a detection signal indicating a steering operation value to a controller 101. The steering angle detector 47 is, for example, a steering angle sensor, such as a rotary encoder.

The steering system 41 described above is an example, and is not limited to the above-described configuration. For example, when independent driving of the respective electric motors 34 allows the traveling device 21 to vary one propelling force and the other propelling force in the width direction to change the rudder angle, as in the present example embodiment, the traveling device 21 may function as a portion of the steering system 41. In that case, in accordance with the rotational direction of the steering handle 42a (steering shaft 43), the power system 31 changes the driving forces of the electric motors 34 to vary the one propelling force and the other propelling force in the width direction, thus changing the rudder angle.

As illustrated in FIG. 1 and FIG. 2, the working vehicle 1 includes a braking device 51. The braking device 51 can perform braking on the traveling device 21. In the present example embodiment, the braking device 51 can perform braking on the left rear wheel 22R1 and the right rear wheel 22R2. The braking device 51 includes a braking actuator 52 and a braking mechanism 53.

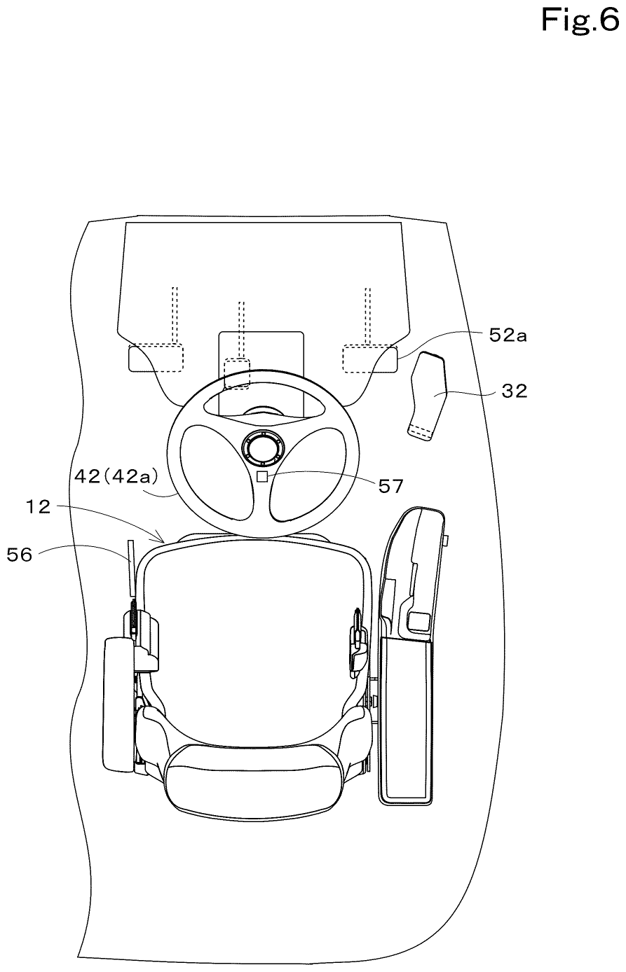

FIG. 6 illustrates the operator's seat 12 and the vicinity thereof. As illustrated in FIG. 6, the braking actuator 52 is provided in the vicinity of the operator's seat 12 and is operated by the operator sitting in the operator's seat 12. The braking actuator 52 may be an operation actuator, such as a pedal (foot pedal), a lever, a button, a switch, or a dial. In the present example embodiment, the braking actuator 52 is a single brake pedal 52a operated to brake the left rear wheel 22R1 and the right rear wheel 22R2. In other words, by operating the single brake pedal 52 a, the left rear wheel 22R1 and the right rear wheel 22R2 are braked simultaneously.

As illustrated in FIG. 1, the braking device 51 includes a parking brake 56 (brake lever) operated to brake the left rear wheel 22R1 and the right rear wheel 22R2. As illustrated in FIG. 6, the parking brake 56 is provided in the vicinity of the operator's seat 12 and is operated by the operator sitting in the operator's seat 12.

The braking mechanism 53 is, for example, a disk-type hydraulic brake. The braking mechanism 53 includes a first braking mechanism 53a capable of braking the left rear wheel 22R1 and a second braking mechanism 53 b capable of braking the right rear wheel 22R2. The first braking mechanism 53a is provided at an axle of the left rear wheel 22R1. The second braking mechanism 53 b is provided at an axle of the right rear wheel 22R2.

When the brake pedal 52a is pressed (e.g., is operated from a released state toward a braking state), the first braking mechanism 53a increases the braking force on the left rear wheel 22R1 and the second braking mechanism 53b increases the braking force to brake the right rear wheel 22R2 in accordance with the amount of operation. In contrast, when the brake pedal 52 a is released (e.g., is returned from the braking state to the released state), the first braking mechanism 53a reduces the braking force on the left rear wheel 22R1 and the second braking mechanism 53 b reduces the braking force on the right rear wheel 22R2 in accordance with the amount of operation.

When the parking brake 56 is operated from a released position to a braking position, the first braking mechanism 53a and the second braking mechanism 53b increase the braking force. In contrast, when the parking brake 56 is operated from the braking position to the released position, the braking mechanism 53 reduces the braking force.

The braking device 51 is not limited to the above-described example, and may perform braking on the left front wheel 22F1 and the right front wheel 22F2 in addition to or in place of the left rear wheel 22R1 and the right rear wheel 22R2.

As illustrated in FIG. 1, the working vehicle 1 includes a one-side braking command actuator 57 that issues a command for performing one-side braking. The one-side braking command actuator 57 simply issues a command for performing one-side braking but does not designate whether the one-side braking is directed to the left side or right side.

As illustrated in FIG. 6, the one-side braking command actuator 57 is provided in the middle of the steering handle 42a. The operator sitting in the operator's seat 12 can operate the one-side braking command actuator 57 while operating the steering handle 42a. The one-side braking command actuator 57 is not limited to being provided in the steering handle 42a and may be provided at a location within an operable range of the operator sitting in the operator's seat 12.

The one-side braking command actuator 57 is, for example, a momentary operation switch that switches to an ON mode only while being pressed and that outputs a one-side braking ON signal to the controller 101. When not pressed, the one-side braking command actuator 57 returns to an OFF mode and does not output a one-side braking ON signal to the controller 101 (or may output a one-side braking OFF signal thereto). The one-side braking command actuator 57 may be an alternating operation switch. Other than a switch, the one-side braking command actuator 57 may be a pedal (foot pedal), lever, a button, a switch, a dial, or the like.

As illustrated in FIG. 1, the working vehicle 1 includes an input interface 57A that receives input of an operation to stop or reduce the rotation speed of inner wheel(s) which are wheel(s) at the inner side of the turn made by the travel vehicle body steered by the steering actuator 42. Examples of the input interface 57A include the one-side braking command actuator 57 and an operation icon that is displayed on a display 103 and that receives a touching operation. The operation icon is, for example, an icon indicating a one-side braking button. In the case of the operation icon, the display 103 (input interface E) outputs a one-side braking ON signal to the controller 101 when the user performs a touching operation on the operation icon, and does not output a one-side braking ON signal to the controller 101 (or may output a one-side braking OFF signal thereto) when a touching operation is not performed.

As illustrated in FIG. 3 and FIG. 4, at least one coupler 61 is capable of coupling the working device 2 to the travel vehicle body 11. The working device 2 can be attached to the coupler 61 in a detachable manner. The coupler 61 is provided at the front portion and/or the rear portion of the travel vehicle body 11 and can couple the working device 2 to the travel vehicle body 11. In the present example embodiment, the couplers 61 are provided at both the front portion and the rear portion of the travel vehicle body 11. Each coupler 61 may be provided at the front portion or the rear portion of the travel vehicle body 11.

The coupler 61 includes, for example, a raising/lowering device 63 that supports the working device 2 in such a manner as to be capable of raising or lowering the working device 2. The raising/lowering device 63 raises or lowers the working device 2 relative to the travel vehicle body 11 so as to be capable of changing the relative position between the travel vehicle body 11 and the working device 2. The raising/lowering device 63 can be coupled to the working device 2. In the example illustrated in FIG. 3 and FIG. 4, the raising/lowering device 63 is provided at the rear portion of the travel vehicle body 11.

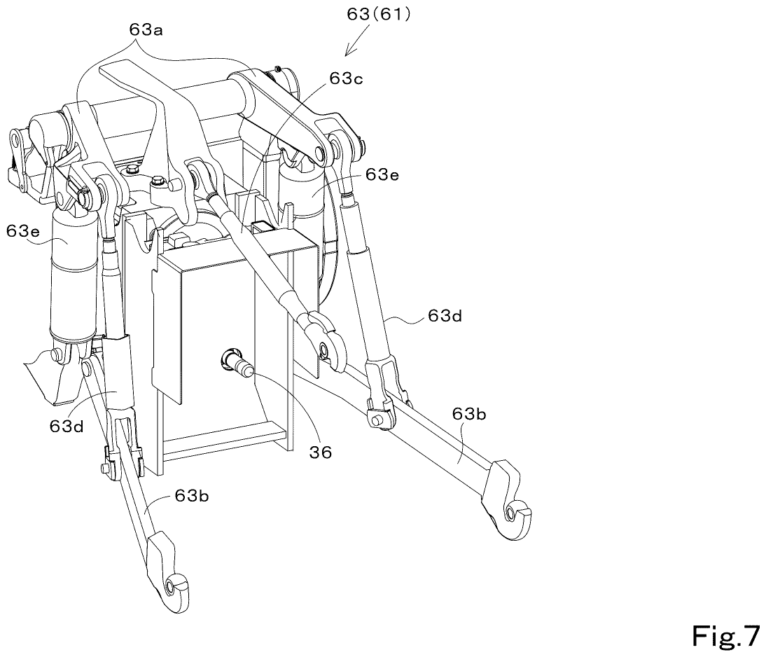

FIG. 7 is a perspective view of the raising/lowering device 63 as viewed from the rear. The raising/lowering device 63 includes a lift arm 63a, a lower link 63b, a top link 63c, a lift rod 63d, and a lift cylinder 63e.

The front end of the lift arm 63a is supported by a rear upper portion of the travel vehicle body 11 in an upwardly or downwardly pivotable manner. The lift arm 63a pivots (ascends or descends) by being driven by the lift cylinder 63e. The lift cylinder 63e includes a hydraulic cylinder. The lift cylinder 63e is connected to a hydraulic pump via a raising/lowering control valve 63f. The raising/lowering control valve 63f is an electromagnetic valve or the like that changes a hydraulic fluid to be supplied from the hydraulic pump to the lift cylinder 63e or a hydraulic fluid to be discharged from the lift cylinder 63e, so as to cause the lift cylinder 63e to extend and retract.

The front end of the lower link 63b is supported by a rear lower portion of the travel vehicle body 11 in an upwardly or downwardly pivotable manner. The front end of the top link 63c is supported above the lower link 63b by the rear portion of the travel vehicle body 11 in an upwardly or downwardly pivotable manner. The lift rod 63d couples the lift arm 63a and the lower link 63b to each other. A rear portion of the lower link 63b and a rear portion of the top link 63c are hook-shaped.

When the lift cylinder 63e is driven (extends and retracts), the lift arm 63a ascends and descends, and the lower link 63b coupled to the lift arm 63a via the lift rod 63d also ascends and descends. Accordingly, the working device 2 pivots (ascends or descends) upward or downward about the front portion of the lower link 63b.

The working device 2 is a device coupled to the travel vehicle body 11 by the coupler 61 and used for performing work. Examples of the working device 2 include a cultivator for performing a cultivation process, a ridger for performing ridging, a ditcher for performing ditching, a harvester for harvesting crops, a mower for mowing grass and/or the like, a tedder for tedding grass and/or the like, a rake for raking grass and/or the like, a baler for baling grass and/or the like, a fertilizer spreader for spreading fertilizers, an agricultural chemical spreader for spreading agricultural chemicals, a separator for separating crops, and a carriage capable of carrying materials and/or the like.

As illustrated in FIG. 3 and FIG. 4, the working device 2 attached to the rear portion of the travel vehicle body 11 may sometimes be referred to as a rear working device 2A (rear implement), and the working device 2 attached to the front portion of the travel vehicle body 11 may sometimes be referred to as a front working device 2B (front implement). For example, the front working device 2B (front implement) is a front loader, for example, but is not limited thereto.

As illustrated in FIG. 1, a battery unit 71 is capable of supplying electric power to drive the working vehicle 1. For example, the battery unit 71 includes a second battery 72 (sub battery, range extender) to supplement the first battery 111 provided in the travel vehicle body 11. The second battery 72 is capable of storing electricity and is, for example, a secondary battery, such as a lithium ion battery or a lead acid battery. The second battery 72 includes multiple cells therein. The multiple cells are electrically connected in series and in parallel. In the present example embodiment, the second battery 72 stores electric power supplied via an external recharger, and supplies the stored electric power directly to the electric motor 34 or indirectly thereto via the first battery 111.

The second battery 72 may store electric power generated by a fuel cell so long as the battery unit 71 is capable of supplying electric power to drive the working vehicle 1. In that case, the battery unit 71 includes, in addition to the second battery 72, a tank to accommodate gas (e.g., hydrogen gas, methane gas, or the like) and a fuel cell (fuel cell stack) to generate electricity in accordance with the gas supplied from the tank.

The units, devices, and the like equipped in the working vehicle 1 will be described in detail below mainly with reference to FIG. 1. As illustrated in FIG. 1, the working vehicle 1 includes the controller 101. The working vehicle 1 also includes a storing device (memory and/or storage) 102.

The controller 101 includes at least one processor. The controller 101 is a controller for the working vehicle 1 and is configured or programmed to perform various types of control related to the working vehicle 1. The controller 101 is communicatively connected to the devices and units equipped in the working vehicle 1 by an in-vehicle network, such as a controller area network (CAN), ISOBUS, LIN (Local Interconnect Network), or FlexRay. The controller 101 can acquire the statuses of the devices and the units via the in-vehicle network. For example, the controller 101 can acquire, via the in-vehicle network, information indicating the attachment status of the working device 2 (attached or detached, attached to the front, and attached to the rear), and information indicating the type of working device 2 (directly attached working device or a towed working device). The controller 101 may acquire these pieces of information by receiving them via an input device (a display unit 103a including a touchscreen, to be described later).

The controller 101 includes, for example, at least one memory, various types of analog circuits, and various types of digital circuits. The at least one memory stores a software program to be performed by the at least one processor, as well as various types of data. The controller 101 can cause the at least one processor to read the software program from the at least one memory and perform various processes based on the software program. The controller 101 may cause the at least one processor to perform various processes based on a predetermined logic circuit.

The processor is, for example, a central processing unit (CPU), a graphics processing unit (GPU), a digital signal processor (DSP), a field programmable gate array (FPGA), an application specific integrated circuit (ASIC), or the like.

The controller 101 may be configured or programmed to perform various processes by causing multiple physically-separated processors to operate in cooperation with each other, and the configuration of the controller 101 is not limited to the above-described configuration. In that case, the multiple processors are each equipped in at least one computer physically separated from the working vehicle 1, and these processors are communicatively connected by a network, such as the in-vehicle network, a local area network (LAN), a wide area network (WAN), and the Internet.

The software program may be stored in the storing device 102 communicatively connected to the controller 101 and in an external server connected via the aforementioned network, and may be installed therefrom into the aforementioned memory.

The storing device 102 is operable to store information. The storing device 102 is a nonvolatile memory, such as a hard disk drive (HDD) or a solid state drive (SSD). The storing device 102 is communicatively connected to the controller 101. The controller 101 causes the storing device 102 to store various types of information, and acquires information stored in the storing device 102.

As illustrated in FIG. 1, the working vehicle 1 includes the display 103. The display 103 includes the display unit 103a, such as a liquid crystal display. The display 103 is controlled by the controller 101 and displays various types of information related to the working vehicle 1. The display 103 is provided in the vicinity of the operator's seat 12. The display unit 103a of the display 103 may be provided with a touchscreen.

As illustrated in FIG. 1, the working vehicle 1 may include a sensor 104 that detects the surrounding conditions. The sensor 104 is communicatively connected to the controller 101 in a wired or wireless manner, and outputs a detection result to the controller 101. The controller 101 can detect an obstacle surrounding the working vehicle 1 based on the detection result of the sensor 104, or can estimate the position of the working vehicle 1 based on the detection result (detection point group data) and environmental map information stored in the storing device 102 and/or the like. In the following description, the position of the working vehicle 1 estimated based on the detection result may be referred to as an estimated position.

The sensor 104 includes an optical distance measuring sensor, a signal processing circuit, and the like. The optical distance measuring sensor of the sensor 104 may be, for example, LiDAR (Light Detection and Ranging).

LiDAR (laser sensor) radiates pulsed measurement light (laser light) 1,000,000 times per second from a light source, such as a laser diode, and scans the measurement light in the horizontal direction or the vertical direction by reflecting it on a rotating mirror, thus projecting the measurement light onto a predetermined detection range (sensing range of, for example, 360°). Then, the LiDAR causes a light receiver to receive reflected light reflected by a target object of the measurement light. The signal processing circuit detects the distance to the target object based on a time period from when the measurement light is radiated from the LiDAR to when the reflected light is received (time-of-flight (ToF) technique).

Other than LiDAR, the optical distance measuring sensor of the sensor 104 may be an imager, such as a charge coupled device (CCD) camera equipped with a CCD image sensor or a complementary metal oxide semiconductor (CMOS) camera equipped with a CMOS image sensor, or may be a ToF camera. Although the above example relates to a case where the sensor 104 includes the optical distance measuring sensor, a sonic distance measuring sensor (e.g., an airborne ultrasonic sensor, such as sonar) may be used as an alternative to the optical distance measuring sensor.

As illustrated in FIG. 1, the working vehicle 1 may include a position measurer 105. The position measurer 105 is a device that measures the position of the working vehicle 1 (detects the position of the working vehicle 1). The position measurer 105 is communicatively connected to the controller 101 and outputs the measured position of the working vehicle 1 to the controller 101. The position measurer 105 receives a satellite signal from a satellite positioning system via a global positioning system (GPS) antenna, and measures the position of the working vehicle 1 in accordance with the satellite signal. The position measurement performed on the working vehicle 1 by the position measurer 105 involves measuring a predetermined position of the working vehicle 1. In the following description, the position of the working vehicle 1 measured by the position measurer 105 may be referred to as a measured position. In addition to the measured position, the position measurer 105 may detect the direction of the working vehicle 1 (e.g., the direction in which the front of the travel vehicle body 11 is oriented, or the vehicle body orientation).

As illustrated in FIG. 1, the working vehicle 1 may include a posture detector 106. The posture detector 106 detects the posture of the working vehicle 1 (travel vehicle body 11). The posture detector 106 is communicatively connected to the controller 101 and outputs the detected orientation of the travel vehicle body 11 to the controller 101. In detail, the posture detector 106 detects a three-dimensional inertial motion of the travel vehicle body 11 as the orientation of the travel vehicle body 11. The posture detector 106 is, for example, an inertial measurement unit (IMU) including an acceleration sensor and a gyroscope sensor. The posture detector 106 detects, for example, tilt information of the travel vehicle body 11 (roll angle, pitch angle, and yaw angle).

As illustrated in FIG. 1, the working vehicle 1 includes the input interface E. The input interface E receives input of information. The input interface E is communicatively connected to the controller 101 and outputs the received input information to the controller 101.

The input interface E receives, for example, an operation performed by the operator and outputs information (operation information, operation signal) based on the operation to the controller 101. In that case, the input interface E includes at least one operation actuator that receives an operation performed by the operator. The operation actuator is of a hardware type, such as a physical lever or switch, or of a software type, such as a display image that is displayed on the display unit 103a of the display 103 and that is operable. The operation actuator of the software type receives an operation performed by the operator operating the touchscreen.

As illustrated in FIG. 1, the controller 101 is configured or programmed to include a travel controller 101a. The travel controller 101a acquires the input information received by the input interface E and controls each device, each unit, and/or the like included in the working vehicle 1 in accordance with the information. The controller 101 functions as the travel controller 101a by causing the at least one processor to execute program(s). A detailed example of the input interface E and control performed by the travel controller 101a based on the input information received by the input interface E will be described below.

The input interface E receives input of a travel command related to travel by the traveling device 21. When the input interface E receives the input of the travel command, the travel controller 101a acquires the travel command and controls the travel by the traveling device 21. The travel command may be, for example, an operation command of the power system 31.

The input interface E that receives the operation command (travel command) of the power system 31 is an accelerator actuator 32. The accelerator actuator 32 receives an operation related to power to be supplied from the power system 31 to the traveling device 21. The accelerator actuator 32 includes, for example, an accelerator pedal, an accelerator lever, and/or the like, detects the operation (the direction of operation, the amount of operation, and/or the like) by using a sensor, and outputs the operation as an operation signal to the controller 101.

When acquiring the operation signal (travel command, operation command) from the accelerator actuator 32, the travel controller 101a controls the power system 31 based on a predetermined control table, an arithmetic expression, and/or the like stored in the storing device 102 and also based on the operation signal. In detail, based on the operation signal from the accelerator actuator 32, the travel controller 101a controls the rotation speed of the electric motor 34 so as to control the traveling device 21.

The travel controller 101a can control the inverters 74 in accordance with the operation signal from the accelerator actuator 32, so as to be capable of arbitrarily changing the electric current and voltage of the electric power to be supplied to the electric motor 34. For example, as the operation amount of the accelerator actuator 32 increases, the travel controller 101a increases the rotation speed of the electric motor 34 by increasing the electric power supplied to the electric motor 34. In contrast, as the operation amount of the accelerator actuator 32 decreases, the travel controller 101a decreases the rotation speed of the electric motor 34 by reducing the electric power supplied to the electric motor 34.

The travel command is not limited to the operation command of the power system 31 so long as the travel command is an operation command related to travel by the traveling device 21. For example, as illustrated in FIG. 2, if the travel controller 101a is capable of controlling the braking device 51, the input interface E may receive input of an operation command of the braking device 51 as the travel command.

The braking device 51 illustrated in FIG. 2 includes a hydraulic actuator unit 54. The hydraulic actuator unit 54 is activated by a hydraulic fluid and actuates the braking mechanism 53. The hydraulic actuator unit 54 includes a first hydraulic actuator unit 54a that actuates the first braking mechanism 53a and a second hydraulic actuator unit 54b that actuates the second braking mechanism 53b. The first hydraulic actuator unit 54a and the second hydraulic actuator unit 54b are, for example, brake master cylinders. Although the first hydraulic actuator unit 54a and the second hydraulic actuator unit 54b are provided as two hydraulic actuator units in FIG. 2, a single hydraulic actuator unit 54 (e.g., a brake master cylinder) may actuate the first braking mechanism 53a and the second braking mechanism 53b.

A first braking control valve 55a is connected to the first hydraulic actuator unit 54a via a fluid passage. The first braking control valve 55a is, for example, an electromagnetic valve that is controlled by the travel controller 101a and that actuates the first hydraulic actuator unit 54a. On the other hand, a second braking control valve 55b is connected to the second hydraulic actuator unit 54b via a fluid passage. The second braking control valve 55b is, for example, an electromagnetic valve that is controlled by the travel controller 101a and that actuates the second hydraulic actuator unit 54b.

The input interface E that receives the operation command (travel command) of the braking mechanism 53 is, for example, the braking actuator 52. In that case, the braking actuator 52 detects an operation (the direction of operation, the amount of operation, and/or the like) on the brake pedal 52a, the parking brake 56, and the like by using a sensor, and outputs the operation as an operation signal to the controller 101.

When acquiring the operation signal (travel command, operation command) from the braking actuator 52, the travel controller 101a performs regenerative coordinated braking control based on a predetermined control table, an arithmetic expression, and/or the like stored in the storing device 102, as well as the operation signal and the rotation speed of each electric motor 34. Regenerative coordinated braking control is braking control involving causing a braking force (hydraulic braking force) by the braking mechanism 53 (hydraulic brake) and a regeneration-based braking force (regenerative braking force) to coordinate with each other to obtain a braking force corresponding to the operation signal from the braking actuator 52.

The travel controller 101a computes a braking force based on the operation signal from the braking actuator 52 and the rotation speed of each electric motor 34, and performs a computation for distributing the braking force into a regenerative braking force and a hydraulic braking force by using the control table, the arithmetic expression, and/or the like, thus causing the regenerative braking force and the hydraulic braking force to occur. For example, in the case of a weak braking operation (when the operation amount of the braking actuator 52 is a first operational amount), the travel controller 101a causes the regenerative braking force alone to occur. In the case of a strong braking operation (when the operation amount of the braking actuator 52 is a second operational amount larger than the first operational amount), the travel controller 101a causes the regenerative braking force and the hydraulic braking force to occur.

In detail, the travel controller 101a causes the regenerative braking force to occur by setting each electric motor 34 to a regenerative mode until the rotation speed of the electric motor 34 is stopped or reduced to a target rotation speed. The regenerative mode involves rotating the electric motor 34 with the kinetic energy of the travel vehicle body 11 to recover the kinetic energy of the travel vehicle body 11 as electrical energy. Regenerative braking in the rotation-speed-controlled electric motor involves causing the electric motor 34 to generate negative torque to recharge the battery by setting the target rotation speed lower than the actual rotation speed. More specifically, control is performed to prevent sudden braking by providing this negative torque (negative value) with a threshold value or by providing the rate of change in the rotation speed (amount of change in the rotation speed per unit time) with a threshold value. The travel controller 101a actuates the braking mechanism 53 by outputting a control signal corresponding to the hydraulic braking force to the braking control valve (the first braking control valve 55a and/or the second braking control valve 55b), thus causing the hydraulic braking force to occur (i.e., applying hydraulic braking). Although the regenerative coordinated braking control involves performing regenerative braking in the first half of the braking period and performing hydraulic braking after the regenerative braking, the regenerative coordinated braking control may involve performing the regenerative braking and the hydraulic braking simultaneously over the entire braking period or at least in the second half of the braking period.

With regard to the hydraulic braking force, as the operation amount of the brake pedal 52a increases, the travel controller 101a reduces the openings of the first braking control valve 55a and the second braking control valve 55b, and causes the hydraulic actuator unit 54 to increase the braking force by the braking mechanism 53. In contrast, as the operation amount of the brake pedal 52a decreases, the travel controller 101a increases the openings of the first braking control valve 55a and the second braking control valve 55b, and causes the hydraulic actuator unit 54 to reduce the braking force by the braking mechanism 53.

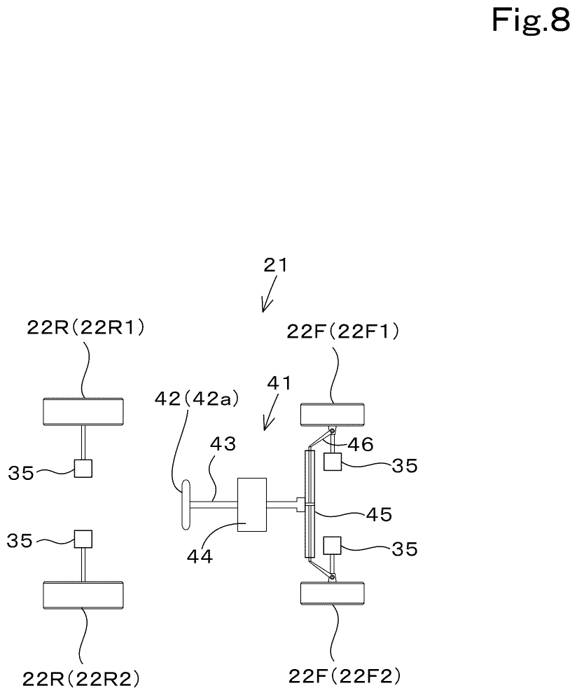

FIG. 8 illustrates another example of the devices and units related to travel by the traveling device 21. The traveling device 21 illustrated in FIG. 8 may be configured not to include the first braking mechanism 53a, the second braking mechanism 53b, the hydraulic actuator unit 54, the first braking control valve 55a, and the second braking control valve 55b. The travel controller 101a may stop the travel vehicle body 11 by stopping the electric motor 34. In other words, a stopping function for the electric motor 34 by the travel controller 101a corresponds to the braking mechanism 53.

The input interface E that receives an operation command (travel command) of the steering system 41 is, for example, the steering actuator 42. In that case, the steering actuator 42 detects the rotational direction and the rotational angle of the steering handle 42a by using a sensor, and outputs the rotational direction and the rotational angle as an operation signal to the controller 101.

When acquiring the operation signal (steering command, operation command) from the steering actuator 42, the travel controller 101a controls the steering of the front wheels 22F based on a predetermined control table, an arithmetic expression, and/or the like stored in the storing device 102 and also based on the operation signal. In detail, the travel controller 101a switches the steering control valve 44 in accordance with the operation signal from the steering actuator 42 and moves the arm 46 in accordance with extension and retraction of the steering cylinder 45, thus changing the steering of the front wheels 22F.

Specifically, as the operation amount of the steering handle 42a increases, the travel controller 101a increases the opening of the steering control valve 44 and uses the steering cylinder 45 to increase the rudder angle. In contrast, as the operation amount of the steering handle 42a decreases, the travel controller 101a reduces the opening of the steering control valve 44 and uses the steering cylinder 45 to decrease the rudder angle.

In addition to or in place of the travel command, the input interface E may receive input of a work command related to work by the working device 2. When the input interface E receives input of a work command, the travel controller 101a acquires the work command and controls the work by the working device 2. The work command may be, for example, an operation command of the raising/lowering device 63.

The input interface E that receives the operation command (work command) of the raising/lowering device 63 is a raising/lowering actuator 62. The raising/lowering actuator 62 receives an operation to raise or lower the raising/lowering device 63. The raising/lowering actuator 62 includes a raising/lowering lever, detects an operation (the direction of operation and/or the amount of operation) on the raising/lowering lever by using a sensor, and outputs the operation as an operation signal to the controller 101. The raising/lowering actuator 62 may include a raising/lowering switch separately from the raising/lowering lever, and may output an operation signal detected by the raising/lowering switch to the controller 101.

When acquiring the operation signal (work command, operation command) from the raising/lowering actuator 62, the travel controller 101a controls the raising/lowering device 63 based on a predetermined control table, an arithmetic expression, and/or the like stored in the storing device 102 and also based on the operation signal. In detail, the travel controller 101a can control the raising/lowering control valve 63f in accordance with the operation signal from the raising/lowering actuator 62, so as to be capable of changing the hydraulic fluid to be supplied from the hydraulic pump to the lift cylinder 63e via the raising/lowering control valve 63f or the hydraulic fluid to be discharged from the lift cylinder 63e via the raising/lowering control valve 63f.

The work command is not limited to the operation command of the raising/lowering device 63 so long as the work command is an operation command related to work by the working device 2. For example, the input interface E may receive input of an operation command for the rotation speed of the PTO shaft 36 as the work command.

The input interface E that receives the operation command for the rotation speed of the PTO shaft 36 is a rotation actuator 33. The rotation actuator 33 includes, for example, a dial or the like switchable to multiple positions, uses a sensor to detect an operation (switched position) on the dial or the like, and outputs the operation as an operation signal to the controller 101.

When acquiring the operation signal (work command, travel command) from the rotation actuator 33, the travel controller 101a controls the fifth electric motor 34e, which rotates the PTO shaft 36, based on a predetermined control table, an arithmetic expression, and/or the like stored in the storing device 102 and also based on the operation signal.

In detail, the travel controller 101a controls the inverters 74 in accordance with the operation signal from the rotation actuator 33 and arbitrarily changes the electric current and voltage of the electric power to be supplied to the fifth electric motor 34e. For example, as the operation amount of the rotation actuator 33 increases, the travel controller 101a increases the rotation speed of the PTO shaft 36 by increasing the electric power supplied to the fifth electric motor 34e. In contrast, as the operation amount of the rotation actuator 33 decreases, the travel controller 101a decreases the rotation speed of the PTO shaft 36 by reducing the electric power supplied to the fifth electric motor 34e.

The input interface E is not limited to the above-described example, and may include an operation switch to control the start, the end, and/or the like of autonomous driving control if the working vehicle 1 is operable based on autonomous driving control.

The input interface E is not limited to an operation actuator that receives an operation performed by the operator so long as the input interface E can receive input of information and output the received input information to the controller 101. For example, the input interface E may include a communicator 107 that receives information transmitted from an external source. The communicator 107 is a communication interface of the working vehicle 1 and includes a communication circuit. The communicator 107 wirelessly communicates with an external server, a portable terminal, a remote controller, and/or the like by using, for example, WiFi (Wireless Fidelity, registered trademark) of the communication standard IEEE 802.11 series, a mobile phone communication network, a data communication network, and/or the like. The communicator 107 wirelessly communicates with the server and/or the like to receive various types of information, data, signals, and/or the like. The communicator 107 may also serve as an output interface capable of outputting (transmitting) various types of information, data, signals, and/or the like to the server and/or the like.

For example, if the working vehicle 1 is operable based on remote driving control, the communicator 107 receives an operation command (travel command and/or work command) transmitted from a remote controller, and outputs the operation command as an operation signal to the controller 101. Accordingly, when acquiring each operation signal (operation command), the travel controller 101a controls each device and each unit based on the operation signal. If the working vehicle 1 is operable based on autonomous driving control, the communicator 107 receives an operation command (travel command and/or work command) transmitted from a remote controller used for controlling the start, the end, and/or the like of the autonomous driving control, and outputs the operation command as an operation signal to the controller 101. Accordingly, when acquiring each operation signal (operation command), the travel controller 101a controls the start, the end, and/or the like of the autonomous driving control based on the operation signal.

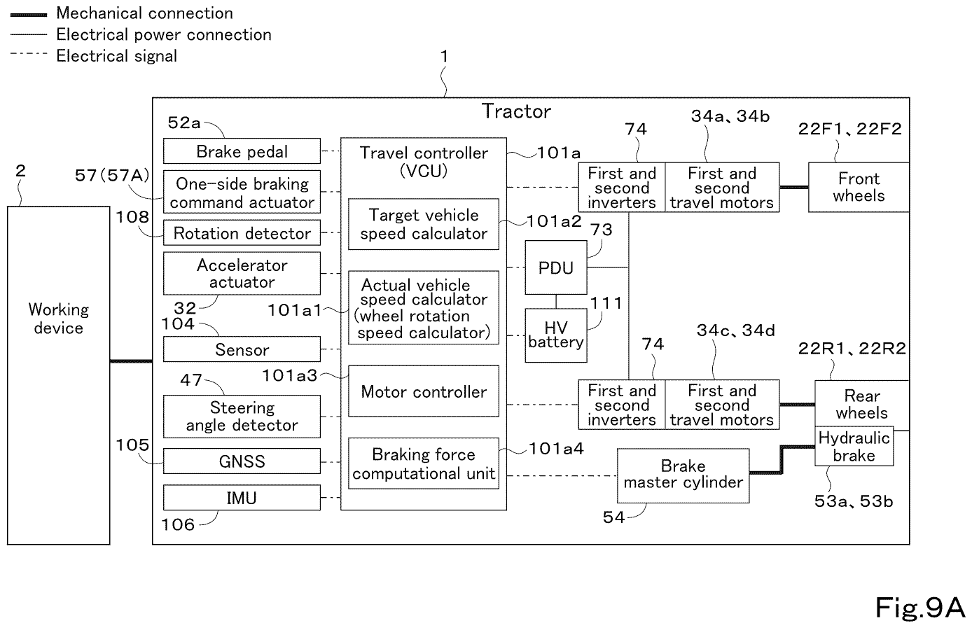

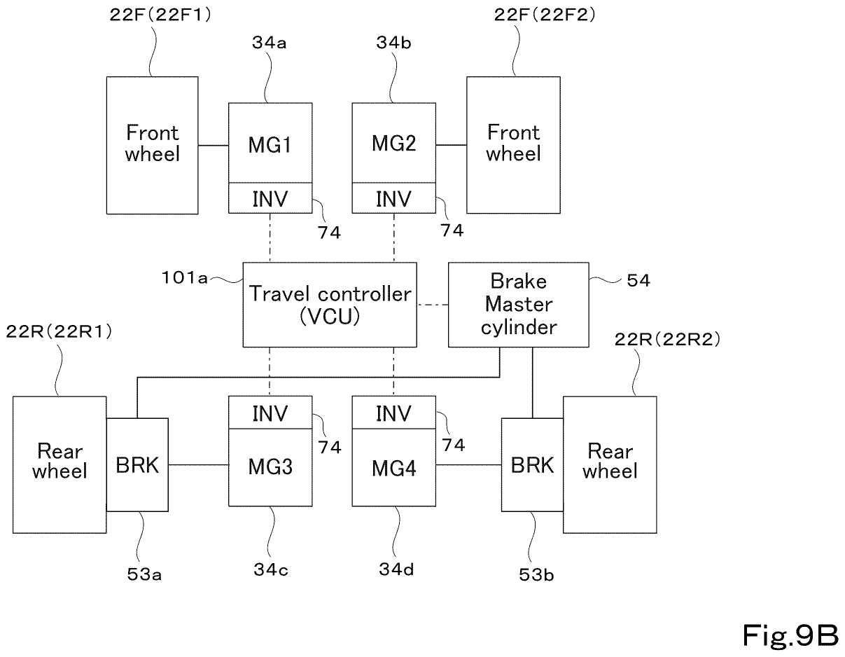

The detailed configuration of and the travel control by the travel controller 101a will now be described with reference to FIG. 9A and FIG. 9B. FIG. 9A illustrates the travel controller 101a, peripheral devices, and the like of the working vehicle 1. FIG. 9B illustrates that the travel controller 101a controls the electric motor 34 and the braking mechanism 53.

As illustrated in FIG. 1 and FIG. 9A, the working vehicle 1 includes at least one rotation detector 108. The rotation detector 108 is communicatively connected to the controller 101 and outputs a detection result to the controller 101. The rotation detector 108 detects rotation of the traveling device 21. The rotation detector 108 is, for example, an optical or magnetic rotation sensor. For example, the rotation detector 108 detects the rotation of the traveling device 21 as a pulse signal and outputs the pulse signal to the controller 101. In the present example embodiment, the rotation detector 108 is provided at the output shaft of each electric motor 34.

As illustrated in FIG. 9A, the travel controller 101a includes an actual vehicle speed calculator 101a1, a target vehicle speed calculator 101a2, a motor controller 101a3, and a braking force computational unit 101a4.

The actual vehicle speed calculator 101a1 calculates an actual speed of the traveling device 21. For example, the actual vehicle speed calculator 101a1 computes a rotation speed of the traveling device 21 per predetermined time based on the detection result output from the rotation detector 108, and calculates an actual vehicle speed of the traveling device 21 from the computed rotation speed of the traveling device 21. Although the actual vehicle speed is determined (i.e., the actual vehicle speed is detected) by the rotation detector 108 (i.e., a wheel speed sensor), this does not imply any limitation. For example, as a variation, the inverters 74 (or the controller 101) may calculate a motor rotation speed from the electric current value, frequency, and/or the specifications of the electric motor 34, and may compute an actual rotation speed by multiplying the calculated rotation speed (motor RPM) of the electric motor 34 by the gear ratio.

The target vehicle speed calculator 101a2 calculates a target vehicle speed of the traveling device 21 based on the operation amount of the accelerator actuator 32 and the actual vehicle speed of the traveling device 21 calculated by the actual vehicle speed calculator 101a1. For example, the target vehicle speed increases in proportion to the operation amount of the accelerator actuator 32.

The motor controller 101a3 calculates a target rotation speed of each electric motor 34 from the target vehicle speed calculated by the target vehicle speed calculator 101a2. As illustrated in FIG. 9A and FIG. 9B, the motor controller 101a3 controls the inverters 74 to change the electric power to be supplied to the respective electric motors 34 (the first electric motor 34a to the fourth electric motor 34d) to an electric power for achieving the target rotation speed, thus setting each electric motor 34 to the target rotation speed.

The braking force computational unit 101a4 computes a braking force based on an amount by which the brake pedal 52a is pressed and the rotation speed of each electric motor 34 detected by the rotation detector 108, and performs a computation for distributing the braking force into a regenerative braking force and a hydraulic braking force. The target vehicle speed calculator 101a2 calculates a rotation speed corresponding to a regenerative braking force. The motor controller 101a3 causes the inverters 74 to set the electric motors 34 to a regenerative mode until the rotation speed of each electric motor 34 reaches the rotation speed corresponding to the target vehicle speed that is calculated by the target vehicle speed calculator 101a2 and that is a value smaller than the actual vehicle speed. If there is allocation of a hydraulic braking force, the braking force computational unit 101a4 outputs a control signal corresponding to the hydraulic braking force to the braking control valve (the first braking control valve 55a and/or the second braking control valve 55b illustrated in FIG. 2) after the regenerative braking of each electric motor 34, and the hydraulic actuator unit 54 (brake master cylinder) actuates the braking mechanism 53 (the first braking mechanism 53a and the second braking mechanism 53b) with the hydraulic braking force, as illustrated in FIG. 9A and FIG. 9B.

The rotation detector 108 may detect the rotation of the axles of the wheels 22 and/or the rotation of a predetermined gear in a power transmission path from the electric motor 34 to drive the wheels 22 to the wheels 22. For example, when the rotation detector 108 is to detect the rotation of the predetermined gear in the power transmission path, the actual vehicle speed calculator 101a1 converts the rotation of the gear into the rotation of each wheel 22 based on a predetermined arithmetic expression or the like stored in the storing device 102.

When the one-side braking command actuator 57 is operated, the travel controller 101a controls the electric motor 34 corresponding to inner wheel(s) at the inner side of the turn made by the travel vehicle body steered by the steering actuator 42 to stop or reduce the rotation speed of the inner wheel(s) based on whether or not the braking actuator 52 is being operated.

In other words, when an operation is input to the input interface 57A in a state where a braking force is applied to both wheels (left and right wheels 22) in accordance with a braking operation (an operation using the braking actuator 52), the travel controller 101a controls the electric motor(s) 34 corresponding to the inner wheel(s) at the inner side of the turn made by the travel vehicle body steered by the steering actuator 42 to stop or reduce the rotation speed of the inner wheel(s). For example, the travel controller 101a further stops or reduces the rotation speed of the inner wheel. The expression “further stops or reduces the rotation speed of the inner wheel” includes stopping or reducing the rotation speed of the inner wheel to a rotation speed lower than a rotation speed based on braking, and stopping or reducing the rotation speed of the inner wheel to a rotation speed lower than a rotation speed immediately before the operation is input to the input interface 57A.

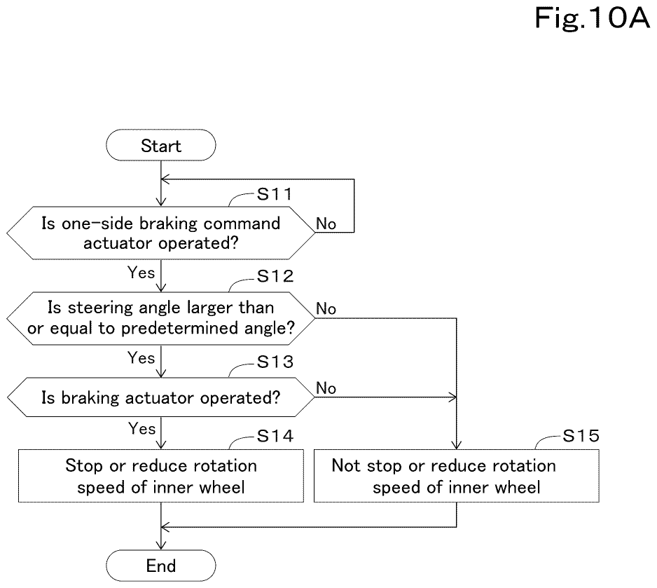

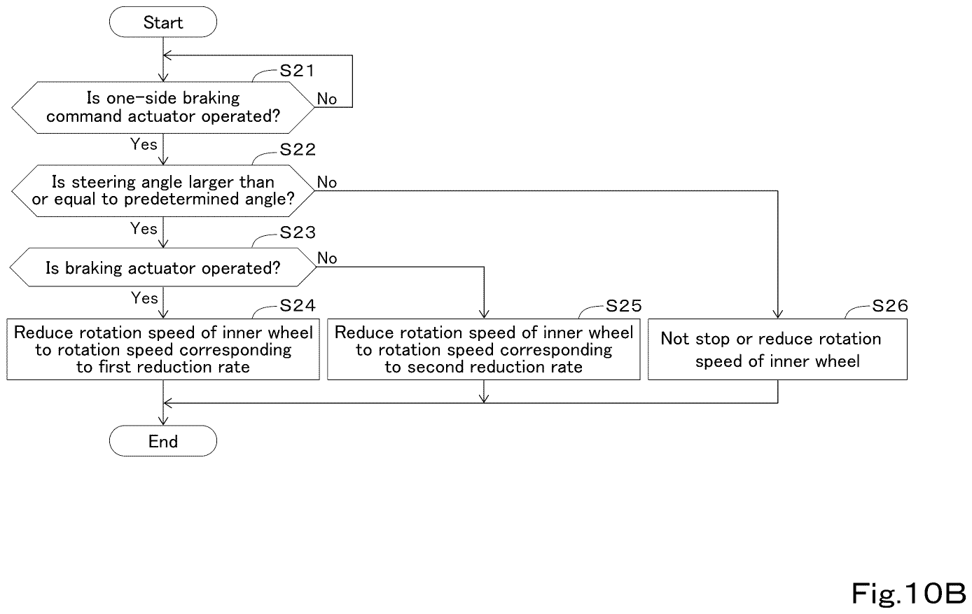

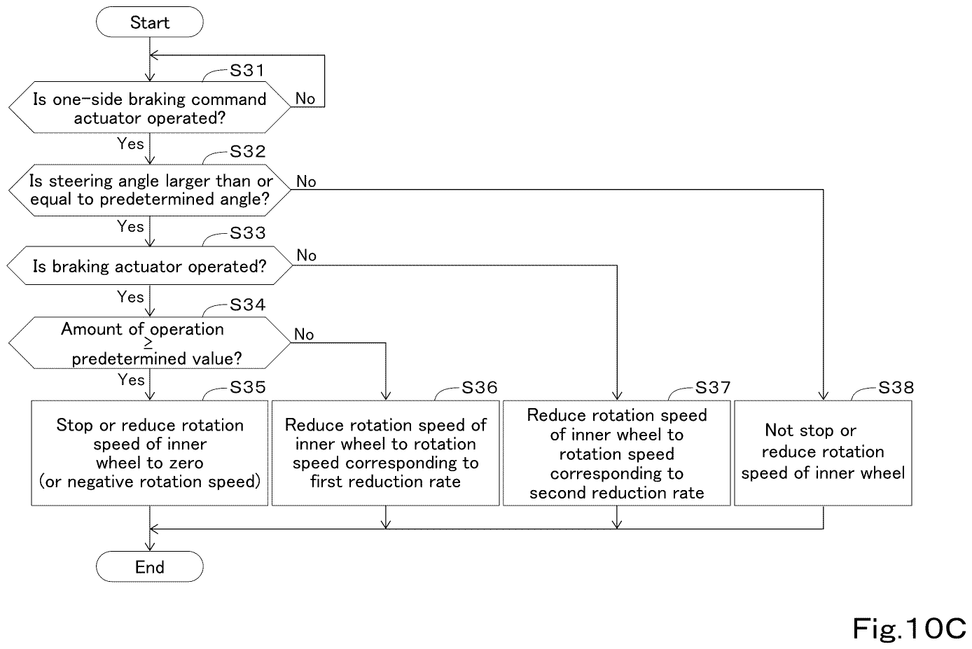

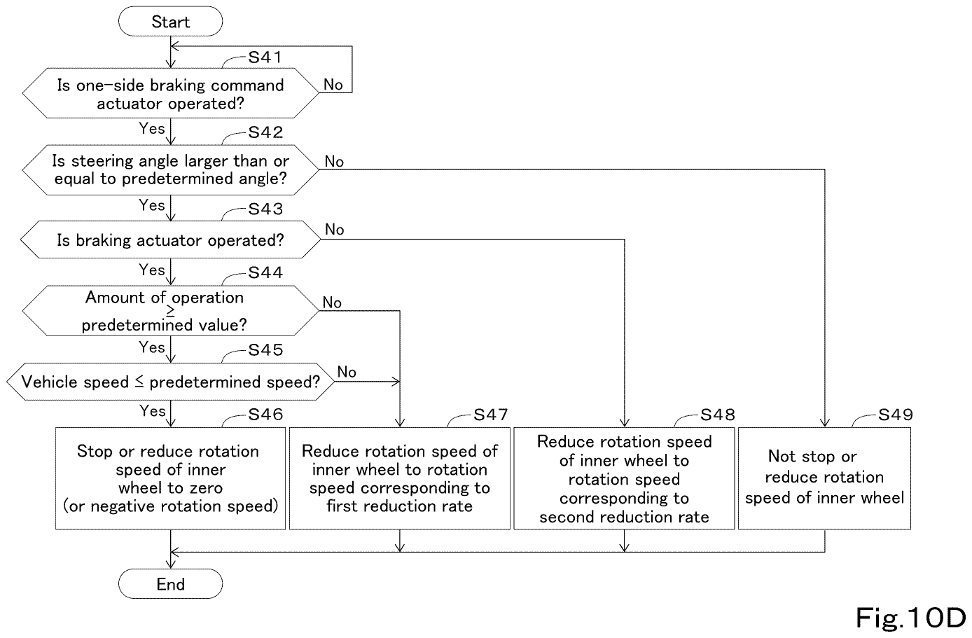

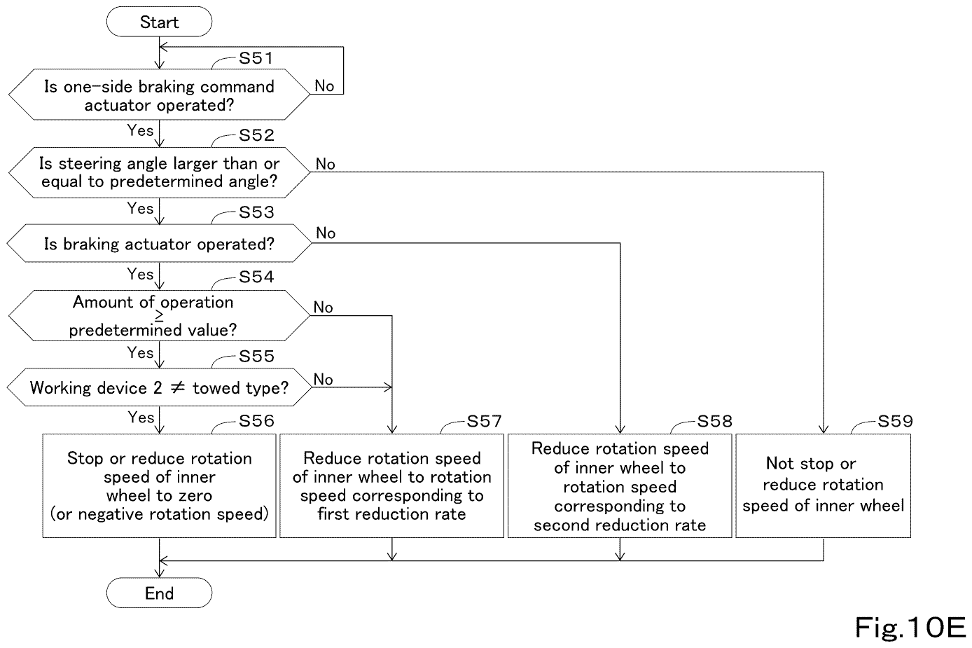

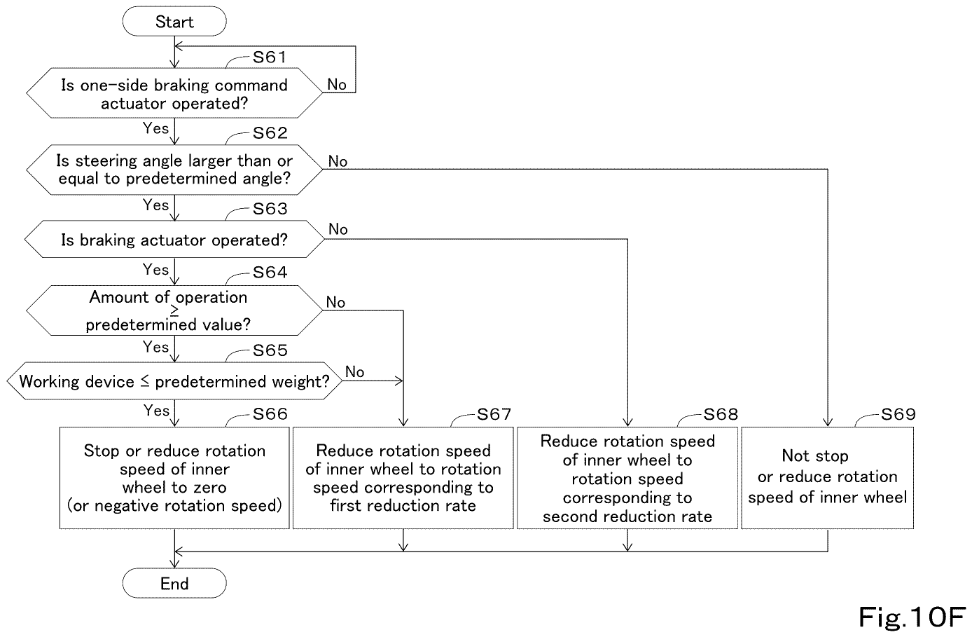

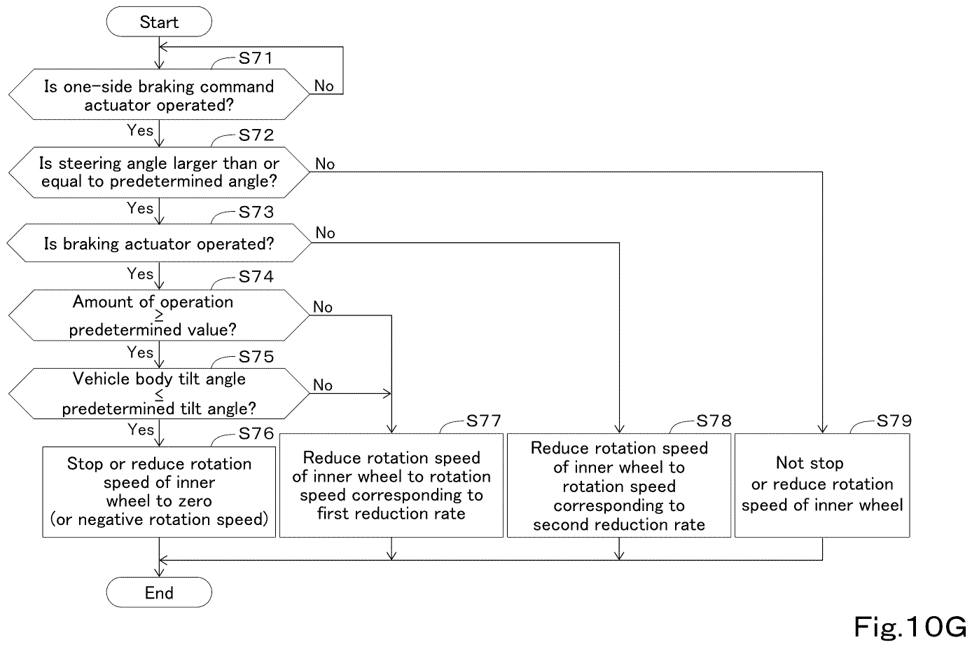

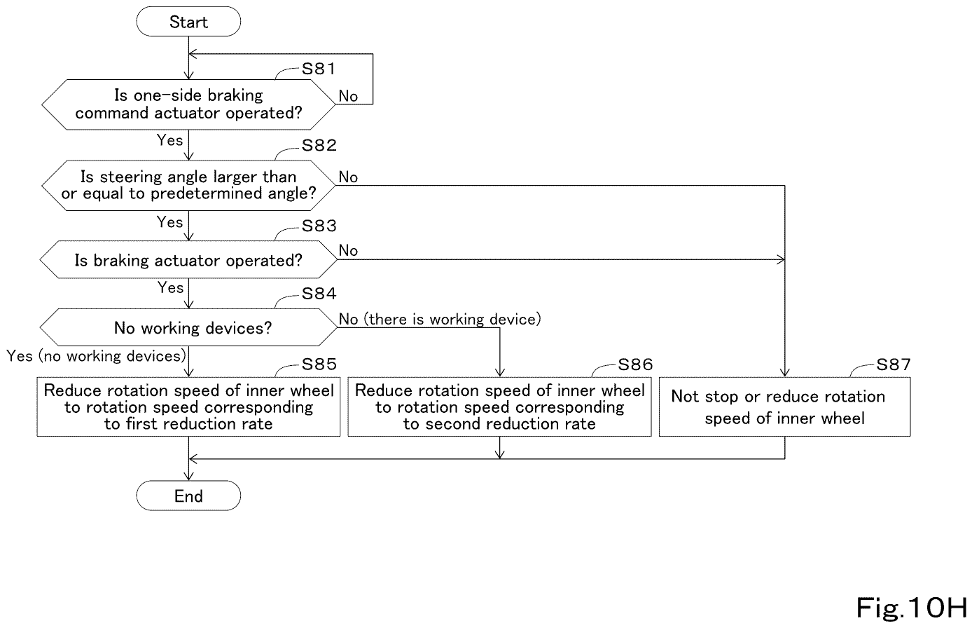

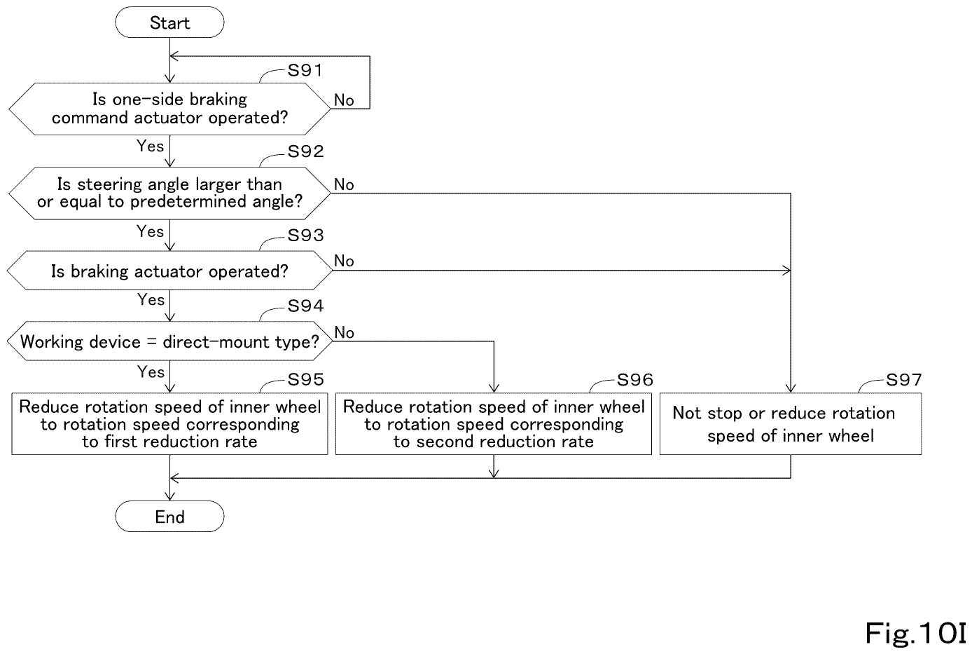

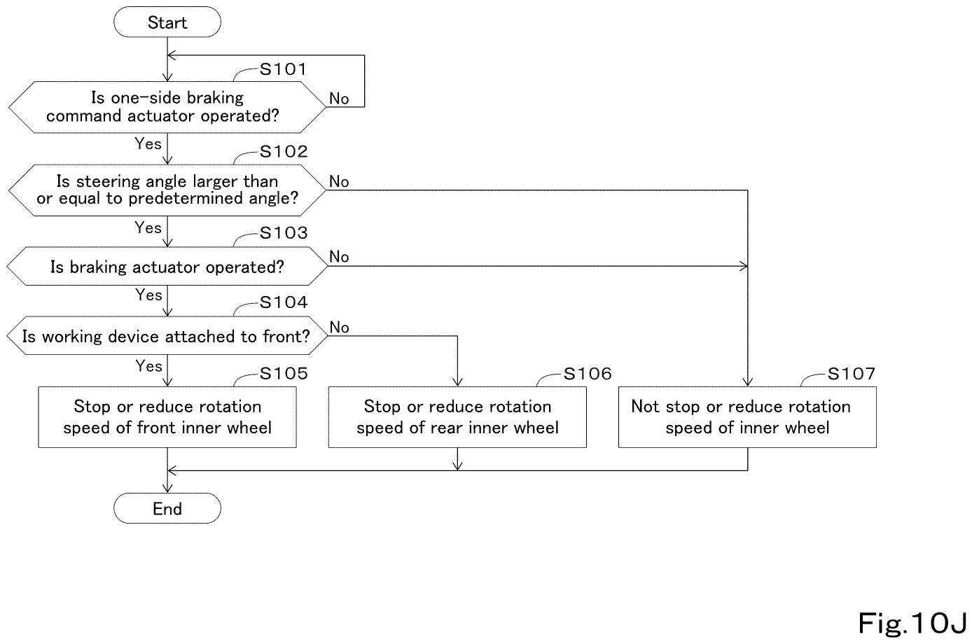

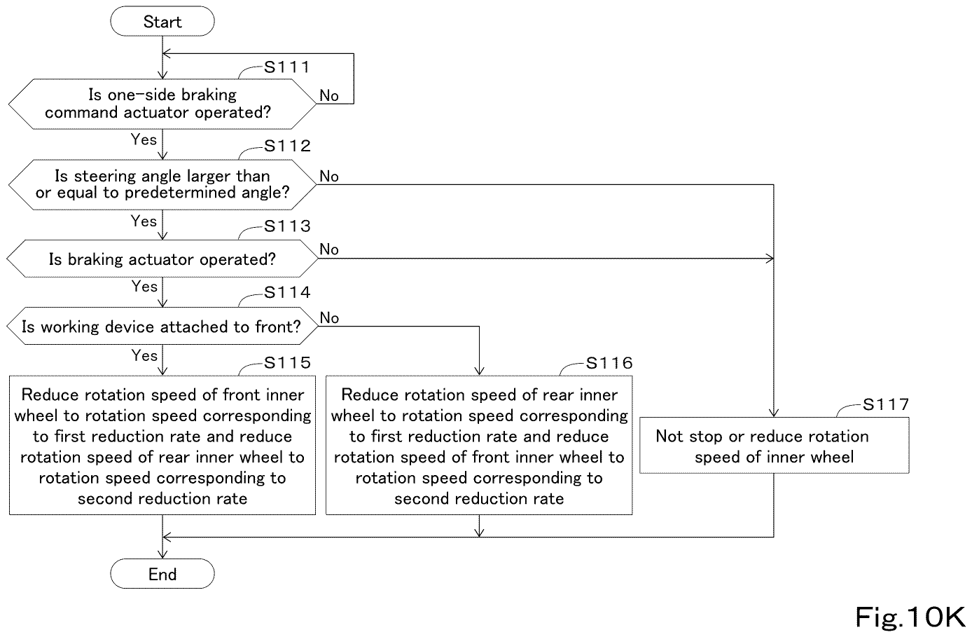

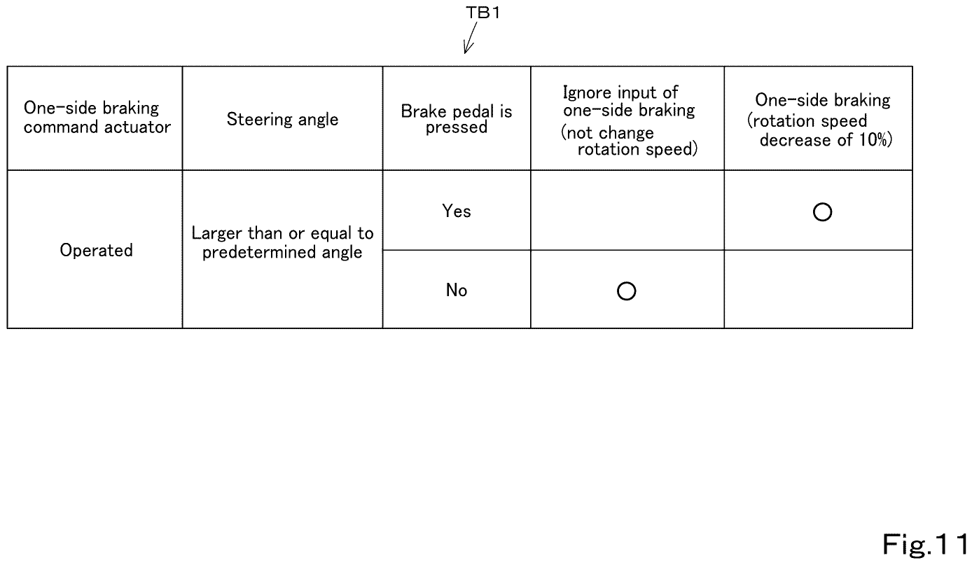

A first example of a travel control process will be described with reference to FIG. 10A and FIG. 11. FIG. 10A is a flowchart illustrating the first example of the travel control process performed by the travel controller 101a. FIG. 11 illustrates a first determination table TB1. For example, as illustrated in FIG. 11, the storing device 102 stores the first determination table TB1 that is used to determine whether or not one-side braking is to be performed and that has the execution details of one-side braking set therein. The first determination table TB1 has stored therein that an operation on the one-side braking command actuator 57 is effective if the one-side braking command actuator 57 is operated, the steering angle of the steering actuator 42 is larger than or equal to a predetermined angle, and the braking actuator 52 is operated (is pressed), and that the operation on the one-side braking command actuator 57 is ineffective if the braking actuator 52 is not operated (is not pressed).

The travel controller 101a uses the first determination table TB1 illustrated in FIG. 11 to determine whether or not one-side braking is to be performed and to determine to perform one-side braking. If the one-side braking command actuator 57 is operated, the steering angle of the steering actuator 42 is larger than or equal to the predetermined angle (turn start angle), and the braking actuator 52 is operated (is pressed), the travel controller 101a determines that the operation on the one-side braking command actuator 57 is effective and performs one-side braking. In contrast, if the braking actuator 52 is not operated (is not pressed), the travel controller 101a determines that the operation on the one-side braking command actuator 57 is ineffective and does not perform one-side braking.

As illustrated in FIG. 10A, the travel controller 101a determines in step S11 whether or not the one-side braking command actuator 57 is operated. If the one-side braking command actuator 57 is not operated (No in step S11), the travel controller 101a returns to step S11. In contrast, if the one-side braking command actuator 57 is operated (Yes in step S11), the travel controller 101a determines in step S12 whether the steering angle of the steering actuator 42 detected by the steering angle detector 47 is larger than or equal to the predetermined angle.

If the steering angle of the steering actuator 42 is larger than or equal to the predetermined angle (Yes in step S12), the travel controller 101a determines in step S13 whether or not the braking actuator 52 is operated. If the braking actuator 52 is operated (Yes in step S13), the travel controller 101a controls at least one electric motor 34 corresponding to at least one inner wheel at the inner side of the turn made by the travel vehicle body steered by the steering actuator 42 to stop or reduce the rotation speed of the inner wheel(s) in step S14.

For example, when the one-side braking command actuator 57 is operated (Yes in step S11), if the braking actuator 52 is operated (Yes in step S13) and the steering actuator 42 is steered for a left turn, the travel controller 101a controls the first electric motor 34a and the third electric motor 34c corresponding to the left front wheel 22F1 and the left rear wheel 22R1 which are inner wheels to stop or reduce the rotation speed of the inner wheels (e.g., by a rotation speed decrease of 10%). In detail, the travel controller 101 a sets the second electric motor 34 b and the fourth electric motor 34 d to the regenerative mode until the right front wheel 22F2 and the right rear wheel 22R2 serving as outer wheels reach the rotation speed corresponding to the regenerative braking force calculated by the braking force computational unit 101a4 and the target vehicle speed calculator 101a2 mentioned above, and sets the first electric motor 34a and the third electric motor 34c to the regenerative mode until the left front wheel 22F1 and the left rear wheel 22R1 which are inner wheels are stopped or reduced to a rotation speed further reduced by 10%, for example, from the rotation speed corresponding to the regenerative braking force.

In the case of steering for a right turn, the travel controller 101a sets the first electric motor 34a and the third electric motor 34c to the regenerative mode until the left front wheel 22F1 and the left rear wheel 22R1 serving as outer wheels reach the rotation speed corresponding to the regenerative braking force, and sets the second electric motor 34b and the fourth electric motor 34 d corresponding to the right front wheel 22F2 and the right rear wheel 22R2 which are inner wheels to the regenerative mode to stop or reduce the rotation speed of the inner wheels (e.g., by a rotation speed decrease of 10%).

In the case of No in step S12 or in the case of No in step S13, the travel controller 101a does not stop or reduce the rotation speed of the at least one inner wheel in step S15. In other words, if the braking actuator 52 is not operated (not pressed), the travel controller 101a determines that the operation on the one-side braking command actuator 57 is ineffective, and does not perform one-side braking.

If the working vehicle 1 is four-wheel drive (4WD), the rotation speed of the inner wheels (the left front wheel 22F1 and the left rear wheel 22R1, or the right front wheel 22F2 and the right rear wheel 22R2) is stopped or reduced. If the working vehicle 1 is two-wheel drive (2WD), the rotation speed of the inner driving wheel is stopped or reduced. For example, in the case of rear-wheel drive, the rotation speed of the inner driving wheel (the left rear wheel 22R1 or the right rear wheel 22R2) is stopped or reduced. In the case of front-wheel drive, the rotation speed of the inner driving wheel (the left front wheel 22F1 or the right front wheel 22F2) is stopped or reduced.

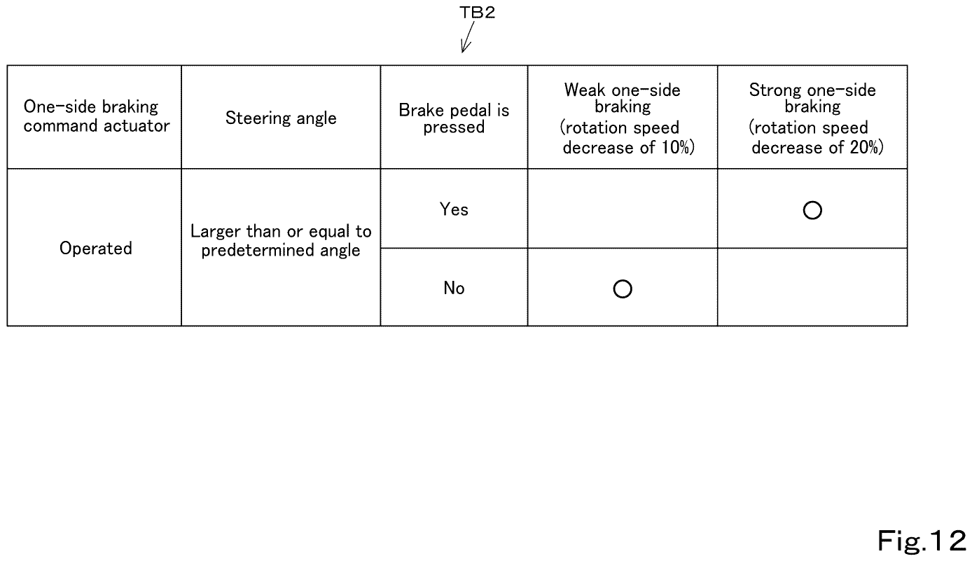

Next, a second example of the travel control process will be described with reference to FIG. 10B and FIG. 12. FIG. 10B is a flowchart illustrating the second example of the travel control process. FIG. 12 illustrates a second determination table TB2. For example, as illustrated in FIG. 12, the storing device 102 stores the second determination table TB2 that has the execution details of one-side braking set therein. The second determination table TB2 has stored therein that strong one-side braking is to be performed if the one-side braking command actuator 57 is operated, the steering angle of the steering actuator 42 is larger than or equal to a predetermined angle, and the braking actuator 52 is operated (is pressed), and that weak one-side braking is to be performed if the braking actuator 52 is not operated (is not pressed).

When the one-side braking command actuator 57 is operated, the travel controller 101a reduces the rotation speed of the inner wheel to a rotation speed corresponding to a first reduction rate (e.g., a rotation speed decrease of 20%) if the braking actuator 52 is being operated, and reduces the rotation speed of the inner wheel to a rotation speed corresponding to a second reduction rate (e.g., a rotation speed decrease of 10%) lower than the first reduction rate if the braking actuator 52 is not being operated. Although the rotation speed decrease with respect to the first reduction rate is 20% as merely an example, a rotation speed decrease other than 20% is also possible. Although the rotation speed decrease with respect to the second reduction rate is 10% as merely an example, a rotation speed decrease other than 10% is also possible so long as it is lower than the first reduction rate.

The travel controller 101a uses the second determination table TB2 illustrated in FIG. 12 to determine the execution details of one-side braking. If the one-side braking command actuator 57 is operated, the steering angle of the steering actuator 42 is larger than or equal to the predetermined angle (turn start angle), and the braking actuator 52 is operated (is pressed), the travel controller 101a reduces the rotation speed of the inner wheel to the rotation speed corresponding to the first reduction rate (e.g., a rotation speed decrease of 20%), thus performing strong one-side braking. In contrast, if the braking actuator 52 is not operated (is not pressed), the travel controller 101a reduces the rotation speed of the inner wheel to the rotation speed corresponding to the second reduction rate (e.g., a rotation speed decrease of 10%), thus performing weak one-side braking.

Since step S21 to step S23 illustrated in FIG. 10B are identical to step S11 to step S13 in FIG. 10A, descriptions thereof will be omitted here. In step S23 illustrated in FIG. 10B, if the braking actuator 52 is operated (Yes in step S23), the travel controller 101a controls at least one electric motor 34 corresponding to at least one inner wheel at the inner side of the turn made by the travel vehicle body steered by the steering actuator 42 to reduce the rotation speed of the inner wheel to the rotation speed corresponding to the first reduction rate (e.g., a rotation speed decrease of 20%) in step S24, thus performing strong one-side braking.

For example, when the one-side braking command actuator 57 is operated (Yes in step S21), if the braking actuator 52 is operated (Yes in step S23) and the steering actuator 42 is steered for a left turn, the travel controller 101a controls the first electric motor 34a and the third electric motor 34c corresponding to the left front wheel 22F1 and the left rear wheel 22R1 which are inner wheels to stop or reduce the rotation speed of the inner wheels (e.g., by a rotation speed decrease of 20%). In other words, the second electric motor 34 b and the fourth electric motor 34 d are set to the regenerative mode such that the right front wheel 22F2 and the right rear wheel 22R2 serving as outer wheels reach the rotation speed corresponding to the regenerative braking force calculated by the braking force computational unit 101a4 and the target vehicle speed calculator 101a2 mentioned above. Moreover, the first electric motor 34a and the third electric motor 34c are set to the regenerative mode such that the left front wheel 22F1 and the left rear wheel 22R1 which are inner wheels are stopped or reduced to a rotation speed further reduced by 20% from the rotation speed corresponding to the regenerative braking force. In the case of steering for a right turn, the second electric motor 34b and the fourth electric motor 34d corresponding to the right front wheel 22F2 and the right rear wheel 22R2 which are inner wheels are controlled to stop or reduce the rotation speed of the inner wheels (e.g., by a rotation speed decrease of 20%).

In the case of No in step S23, when the one-side braking command actuator 57 is operated (Yes in step S21), if the steering angle of the steering actuator 42 is larger than or equal to the predetermined angle (Yes in step S22) and the braking actuator 52 is not operated (No in step S23), the travel controller 101a controls the at least one electric motor 34 corresponding to the at least one inner wheel to reduce the rotation speed of the inner wheel to the rotation speed corresponding to the second reduction rate (e.g., a rotation speed decrease of 10%) in step S25, thus performing weak one-side braking.

In the case of No in step S22, the travel controller 101a does not stop or reduce the rotation speed of the inner wheel in step S26. In other words, if the steering angle is not larger than or equal to the predetermined angle, the travel controller 101a determines that the operation on the one-side braking command actuator 57 is ineffective, and does not perform one-side braking.

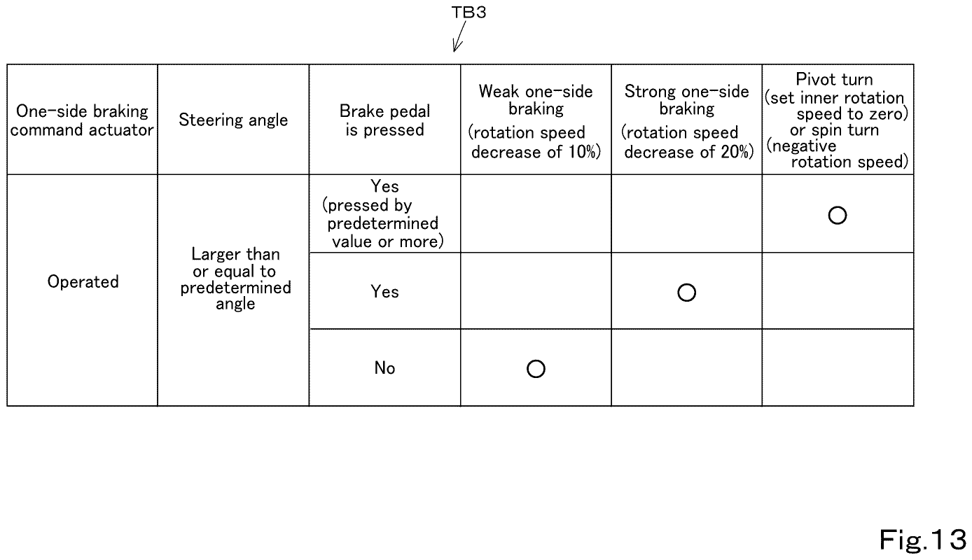

Next, a third example of the travel control process will be described with reference to FIG. 10C and FIG. 13. FIG. 10C is a flowchart illustrating the third example of the travel control process. FIG. 13 illustrates a third determination table TB3. For example, as illustrated in FIG. 13, the storing device 102 stores the third determination table TB3 that has the execution details of one-side braking set therein. The third determination table TB3 has stored therein, in addition to the second determination table TB2, that a pivot turn or a spin turn is to be performed if the one-side braking command actuator 57 is operated, the steering angle of the steering actuator 42 is larger than or equal to a predetermined angle, and the operation amount of the braking actuator 52 is larger than or equal to a predetermined value. The predetermined value corresponds to, for example, a case where the braking actuator 52 is maximally pressed or is pressed to a position short of the maximally pressed position by a certain amount.

When the one-side braking command actuator 57 is operated, if the operation amount of the braking actuator 52 is larger than or equal to the predetermined value, the travel controller 101a controls the rotation speed of the inner wheel to zero or a negative rotation speed. In detail, when the one-side braking command actuator 57 is operated, the travel controller 101a controls the rotation speed of the inner wheel to zero or a negative rotation speed if the operation amount of the braking actuator 52 is larger than or equal to the predetermined value. When the one-side braking command actuator 57 is operated, the travel controller 101a reduces the rotation speed of the inner wheel to the rotation speed corresponding to the first reduction rate (e.g., a rotation speed decrease of 20%) if the operation amount of the braking actuator 52 is smaller than the predetermined value, and reduces the rotation speed of the inner wheel to the rotation speed corresponding to the second reduction rate (e.g., a rotation speed decrease of 10%) lower than the first reduction rate if the braking actuator 52 is not operated.

The travel controller 101a uses the third determination table TB3 illustrated in FIG. 13 to determine the execution details of one-side braking. If the one-side braking command actuator 57 is operated, the steering angle of the steering actuator 42 is larger than or equal to the predetermined angle (turn start angle), and the operation amount of the braking actuator 52 is larger than or equal to the predetermined value, the travel controller 101a stops or reduces the rotation speed of the inner wheel to zero and performs a pivot turn. By stopping or reducing the rotation speed of the inner wheel to a negative rotation speed, the travel controller 101a performs a spin turn. Since strong one-side braking and one-side braking are similar to those in the second example, descriptions thereof will be omitted.

Since step S31 to step S33 illustrated in FIG. 10C are identical to step S21 to step S23 in FIG. 10B, descriptions thereof will be omitted here. In step S34 illustrated in FIG. 10C, if the operation amount of the braking actuator 52 is larger than or equal to the predetermined value (Yes in step S34), the travel controller 101a stops or reduces the rotation speed of the inner wheel(s) at the inner side of the turn made by the travel vehicle body steered by the steering actuator 42 to zero by performing regenerative coordinated braking control using a hydraulic braking force and a regenerative braking force, thus performing a pivot turn in step S35. By stopping or reducing the rotation speed of the inner wheel to a negative rotation speed, the travel controller 101a performs a spin turn in step S35. If the operation amount of the braking actuator 52 is not larger than or equal to the predetermined value (No in step S34), the travel controller 101a controls at least one electric motor 34 corresponding to at least one inner wheel to reduce the rotation speed of the inner wheel to the rotation speed corresponding to the first reduction rate (e.g., a rotation speed decrease of 20%) in step S36, thus performing strong one-side braking.

For example, when the one-side braking command actuator 57 is operated (Yes in step S31), if the steering actuator 42 is steered for a left turn (Yes in step S32) and the operation amount of the braking actuator 52 is larger than or equal to the predetermined value (Yes in step S34), the travel controller 101a controls the first electric motor 34a and the third electric motor 34c corresponding to the left front wheel 22F1 and the left rear wheel 22R1 serving as inner wheels to stop or reduce the rotation speed of the inner wheels to zero (or a negative rotation speed) in step S35.

In the case of No in step S34, the travel controller 101a reduces the rotation speed of the at least one inner wheel to the rotation speed corresponding to the first reduction rate (e.g., a rotation speed decrease of 20%) in step S36, thus performing strong one-side braking. If the braking actuator 52 is not operated (No in step S33), the travel controller 101a controls the at least one electric motor 34 corresponding to the at least one inner wheel to reduce the rotation speed of the inner wheel to the rotation speed corresponding to the second reduction rate (e.g., a rotation speed decrease of 10%) in step S37, thus performing weak one-side braking.

In the case of No in step S32, the travel controller 101a does not stop or reduce the rotation speed of the inner wheel in step S38. In other words, if the steering angle is not larger than or equal to the predetermined angle, the travel controller 101a determines that the operation on the one-side braking command actuator 57 is ineffective and does not perform one-side braking.

Next, a fourth example of the travel control process will be described with reference to FIG. 10D. FIG. 10D is a flowchart illustrating the fourth example of the travel control process.

When the one-side braking command actuator 57 is operated, if the operation amount of the braking actuator 52 is larger than or equal to a predetermined value and a condition where the speed of the travel vehicle body 11 is lower than or equal to a predetermined speed is satisfied, the travel controller 101a controls the rotation speed of the inner wheel to zero or a negative rotation speed. The predetermined speed is a speed at which the working vehicle 1 has no risk of tipping over when the working vehicle 1 makes a pivot turn, and is, for example, a low speed. The low speed is, for example, 10 km/h, but is not limited thereto.

Since step S41 to step S44 and step S46 to step S49 illustrated in FIG. 10D are identical to step S31 to step S34 and step S35 to step S38 in FIG. 10C, descriptions thereof will be omitted here. In step S45 illustrated in FIG. 10D, if the operation amount of the braking actuator 52 is larger than or equal to the predetermined value (Yes in step S44) and the condition where the speed of the travel vehicle body 11 is lower than or equal to the predetermined speed is satisfied (Yes in step S45), the travel controller 101a stops or reduces the rotation speed of the inner wheel(s) at the inner side of the turn made by the travel vehicle body steered by the steering actuator 42 to zero by performing regenerative coordinated braking control using a hydraulic braking force and a regenerative braking force, thus performing a pivot turn in step S46. By stopping or reducing the rotation speed of the inner wheel to a negative rotation speed, the travel controller 101a performs a spin turn in step S46.

In contrast, if the operation amount of the braking actuator 52 is larger than or equal to the predetermined value (Yes in step S44) but the condition where the speed of the travel vehicle body 11 is lower than or equal to the predetermined speed is not satisfied (No in step S45), or if the operation amount of the braking actuator 52 is not larger than or equal to the predetermined value (No in step S44), the travel controller 101a controls the electric motor 34 corresponding to the inner wheel to reduce the rotation speed of the inner wheel to the rotation speed corresponding to the first reduction rate (e.g., a rotation speed decrease of 20%) in step S47, thus performing strong one-side braking.

In step S47, the travel controller 101a may maintain the position of the inner rear wheel or the inner front wheel to prevent the position from changing. For example, by performing feedback control for finely adjusting the inner wheel by forward rotation, zero rotation, or reverse rotation thereof in accordance with positional displacement of the inner rear wheel or the inner front wheel, the position of the inner rear wheel or the inner front wheel is maintained to prevent the position from changing.

Since step S48 (weak one-side braking) and step S49 (no one-side braking) are identical to step S37 (weak one-side braking) and step S38 (no one-side braking) in FIG. 10C, descriptions thereof are omitted here.

Next, a fifth example of the travel control process will be described with reference to FIG. 10E. FIG. 10E is a flowchart illustrating the fifth example of the travel control process.

When the one-side braking command actuator 57 is operated, if the operation amount of the braking actuator 52 is larger than or equal to a predetermined value and the working device 2 connected to the travel vehicle body 11 is of a towed type, the travel controller 101a prohibits control of the rotation speed of the inner wheel to zero or a negative rotation speed. If the working device 2 connected to the travel vehicle body 11 is not of a towed type, the travel controller 101a controls the rotation speed of the inner wheel to zero or a negative rotation speed.

Since step S51 to step S54 and step S56 to step S59 illustrated in FIG. 10E are identical to step S41 to step S44 and step S46 to step S49 in FIG. 10D, descriptions thereof will be omitted here. In step S55 illustrated in FIG. 10E, if the operation amount of the braking actuator 52 is larger than or equal to the predetermined value (Yes in step S54) and the working device 2 connected to the travel vehicle body 11 is of a non-towed type (Yes in step S55), the travel controller 101a stops or reduces the rotation speed of the inner wheel(s) at the inner side of the turn made by the travel vehicle body steered by the steering actuator 42 to zero by performing regenerative coordinated braking control using a hydraulic braking force and a regenerative braking force, thus performing a pivot turn in step S56. By stopping or reducing the rotation speed of the inner wheel to a negative rotation speed, the travel controller 101a performs a spin turn in step S56.

In contrast, if the operation amount of the braking actuator 52 is larger than or equal to the predetermined value (Yes in step S54) but the working device 2 connected to the travel vehicle body 11 is of a towed type (No in step S55), or if the operation amount of the braking actuator 52 is not larger than or equal to the predetermined value (No in step S54), the travel controller 101a controls the electric motor 34 corresponding to the inner wheel to reduce the rotation speed of the inner wheel to the rotation speed corresponding to the first reduction rate (e.g., a rotation speed decrease of 20%) in step S57, thus performing strong one-side braking.

Since step S58 (weak one-side braking) and step S59 (no one-side braking) are identical to step S48 (weak one-side braking) and step S49 (no one-side braking) in FIG. 10D, descriptions thereof are omitted here.

Next, a sixth example of the travel control process will be described with reference to FIG. 10F. FIG. 10F is a flowchart illustrating the sixth example of the travel control process.

When the one-side braking command actuator 57 is operated, the travel controller 101a controls the rotation speed of the inner wheel to zero or a negative rotation speed if the operation amount of the braking actuator 52 is larger than or equal to a predetermined value and the weight of the working device 2 connected to the travel vehicle body 11 is smaller than equal to a predetermined weight, and prohibits control of the rotation speed of the inner wheel to zero or a negative rotation speed if the weight of the working device 2 connected to the travel vehicle body 11 is not smaller than equal to the predetermined weight.

Since step S61 to step S64 and step S66 to step S69 illustrated in FIG. 10F are identical to step S51 to step S54 and step S56 to step S59 in FIG. 10E, descriptions thereof will be omitted here. In step S65 illustrated in FIG. 10F, if the operation amount of the braking actuator 52 is larger than or equal to the predetermined value (Yes in step S64) and the weight of the working device 2 connected to the travel vehicle body 11 is smaller than equal to the predetermined weight (Yes in step S65), the travel controller 101a stops or reduces the rotation speed of the inner wheel(s) at the inner side of the turn made by the travel vehicle body steered by the steering actuator 42 to zero by performing regenerative coordinated braking control using a hydraulic braking force and a regenerative braking force, thus performing a pivot turn in step S66. By stopping or reducing the rotation speed of the inner wheel to a negative rotation speed, the travel controller 101a performs a spin turn in step S66.

In contrast, if the operation amount of the braking actuator 52 is larger than or equal to the predetermined value (Yes in step S64) but the weight of the working device 2 connected to the travel vehicle body 11 is not smaller than equal to the predetermined weight (No in step S65), or if the operation amount of the braking actuator 52 is not larger than or equal to the predetermined value (No in step S64), the travel controller 101a controls the electric motor 34 corresponding to the inner wheel to reduce the rotation speed of the inner wheel to the rotation speed corresponding to the first reduction rate (e.g., a rotation speed decrease of 20%) in step S67, thus performing strong one-side braking.

Since step S68 (weak one-side braking) and step S69 (no one-side braking) are identical to step S58 (weak one-side braking) and step S59 (no one-side braking) in FIG. 10E, descriptions thereof are omitted here.

Next, a seventh example of the travel control process will be described with reference to FIG. 10G. FIG. 10G is a flowchart illustrating the seventh example of the travel control process.

When the one-side braking command actuator 57 is operated, the travel controller 101a controls the rotation speed of the inner wheel to zero or a negative rotation speed under conditions where the operation amount of the braking actuator 52 is larger than or equal to a predetermined value and the tilt angle of the travel vehicle body 11 is smaller than or equal to a predetermined tilt angle, and prohibits control of the rotation speed of the inner wheel to zero or a negative rotation speed if the tilt angle of the travel vehicle body 11 is not smaller than or equal to the predetermined tilt angle.

Since step S71 to step S74 and step S76 to step S79 illustrated in FIG. 10G are identical to step S61 to step S64 and step S66 to step S69 in FIG. 10F, descriptions thereof will be omitted here. In step S75 illustrated in FIG. 10G, if the operation amount of the braking actuator 52 is larger than or equal to the predetermined value (Yes in step S74) and the tilt angle of the travel vehicle body 11 is smaller than or equal to the predetermined tilt angle (Yes in step S75), the travel controller 101a stops or reduces the rotation speed of the inner wheel(s) at the inner side of the turn made by the travel vehicle body steered by the steering actuator 42 to zero by performing regenerative coordinated braking control using a hydraulic braking force and a regenerative braking force, thus performing a pivot turn in step S76. By stopping or reducing the rotation speed of the inner wheel to a negative rotation speed, the travel controller 101a performs a spin turn in step S76.

In contrast, if the operation amount of the braking actuator 52 is larger than or equal to the predetermined value (Yes in step S74) but the tilt angle of the travel vehicle body 11 is not smaller than or equal to the predetermined tilt angle (No in step S75), or if the operation amount of the braking actuator 52 is not larger than or equal to the predetermined value (No in step S74), the travel controller 101a controls the electric motor 34 corresponding to the inner wheel to reduce the rotation speed of the inner wheel to the rotation speed corresponding to the first reduction rate (e.g., a rotation speed decrease of 20%) in step S77, thus performing strong one-side braking.

Since step S78 (weak one-side braking) and step S79 (no one-side braking) are identical to step S68 (weak one-side braking) and step S69 (no one-side braking) in FIG. 10F, descriptions thereof are omitted here.

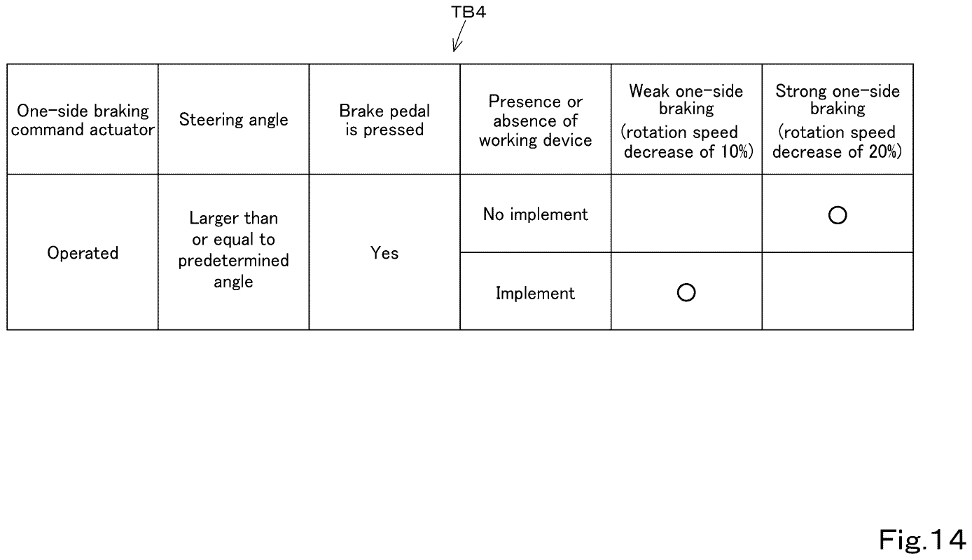

Next, an eighth example of the travel control process will be described with reference to FIG. 10H and FIG. 14. FIG. 10H is a flowchart illustrating the eighth example of the travel control process. FIG. 14 illustrates a fourth determination table TB4. For example, as illustrated in FIG. 14, the storing device 102 stores the fourth determination table TB4 that has the execution details of one-side braking set therein. The fourth determination table TB4 has stored therein that strong one-side braking is to be performed if the one-side braking command actuator 57 is operated, the steering angle of the steering actuator 42 is larger than or equal to a predetermined angle, the braking actuator 52 is operated (is pressed), and the working device 2 is not connected to the travel vehicle body 11, and that weak one-side braking is to be performed if the working device 2 is connected to the travel vehicle body 11.

When the one-side braking command actuator 57 is operated, the travel controller 101a reduces the rotation speed of the inner wheel to the rotation speed corresponding to the first reduction rate if the braking actuator 52 is operated and the working device 2 is not connected to the travel vehicle body 11, and reduces the rotation speed of the inner wheel to the rotation speed corresponding to the second reduction rate lower than the first reduction rate if the working device 2 is connected to the travel vehicle body 11.

The travel controller 101a uses the fourth determination table TB4 illustrated in FIG. 14 to determine the execution details of one-side braking. If the one-side braking command actuator 57 is operated, the steering angle of the steering actuator 42 is larger than or equal to the predetermined angle (turn start angle), the braking actuator 52 is operated, and the working device 2 is not connected to the travel vehicle body 11, the travel controller 101a controls the electric motor 34 corresponding to the inner wheel to reduce the rotation speed of the inner wheel to the rotation speed corresponding to the first reduction rate (e.g., a rotation speed decrease of 20%), thus performing strong one-side braking. In contrast, if the working device 2 is connected to the travel vehicle body 11, the travel controller 101a reduces the rotation speed of the inner wheel to the rotation speed corresponding to the second reduction rate (e.g., a rotation speed decrease of 10%), thus performing weak one-side braking.

Since step S81 to step S83 and step S85 to step S87 illustrated in FIG. 10H are identical to step S21 to step S26 in FIG. 10B, descriptions thereof will be omitted here. In step S84 illustrated in FIG. 10H, if the braking actuator 52 is operated (Yes in step S83) and the travel vehicle body 11 has no working device 2 connected thereto (Yes in step S84), the travel controller 101a controls the electric motor 34 corresponding to the inner wheel to reduce the rotation speed of the inner wheel to the rotation speed corresponding to the first reduction rate (e.g., a rotation speed decrease of 20%) in step S85, thus performing strong one-side braking. In contrast, if the braking actuator 52 is operated (Yes in step S83) but the travel vehicle body 11 has the working device 2 connected thereto (No in step S84), the travel controller 101a controls the electric motor 34 corresponding to the inner wheel to reduce the rotation speed of the inner wheel to the rotation speed corresponding to the second reduction rate (e.g., a rotation speed decrease of 10%) in step S86, thus performing weak one-side braking.

In the case of No in step S82 or in the case of No in step S83, the travel controller 101a does not stop or reduce the rotation speed of the inner wheel in step S87. In other words, if the steering angle is not larger than or equal to the predetermined angle or if the braking actuator 52 is not operated, the travel controller 101a determines that the operation on the one-side braking command actuator 57 is ineffective, and does not perform one-side braking.

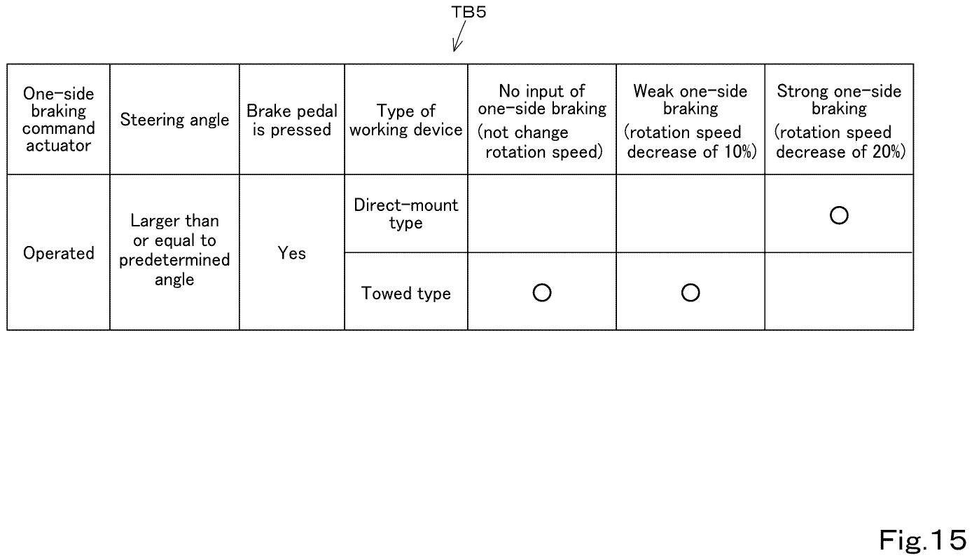

Next, a ninth example of the travel control process will be described with reference to FIG. 10I and FIG. 15. FIG. 10I is a flowchart illustrating the ninth example of the travel control process. FIG. 15 illustrates a fifth determination table TB5. For example, as illustrated in FIG. 15, the storing device 102 stores the fifth determination table TB5 that has the execution details of one-side braking set therein. The fifth determination table TB5 has stored therein that strong one-side braking is to be performed if the one-side braking command actuator 57 is operated, the steering angle of the steering actuator 42 is larger than or equal to a predetermined angle, the braking actuator 52 is operated (is pressed), and the type of working device 2 connected to the travel vehicle body 11 is a directly attached working device, and that weak one-side braking is to be performed if the type of working device 2 is a towed type.

When the one-side braking command actuator 57 is operated, the travel controller 101a reduces the rotation speed of the inner wheel to the rotation speed corresponding to the first reduction rate if the braking actuator 52 is operated and the working device 2 connected to the travel vehicle body 11 is a directly attached working device, and reduces the rotation speed of the inner wheel to the rotation speed corresponding to the second reduction rate if the working device 2 is of a towed type.

The travel controller 101a uses the fifth determination table TB5 illustrated in FIG. 15 to determine whether or not one-side braking is to be performed and to determine the execution details of one-side braking. If the one-side braking command actuator 57 is operated, the steering angle of the steering actuator 42 is larger than or equal to the predetermined angle (turn start angle), the braking actuator 52 is operated, and the type of working device 2 connected to the travel vehicle body 11 is a directly attached working device, the travel controller 101a controls the electric motor 34 corresponding to the inner wheel to reduce the rotation speed of the inner wheel to the rotation speed corresponding to the first reduction rate (e.g., a rotation speed decrease of 20%), thus performing strong one-side braking. In contrast, if the type of working device 2 is a towed type, the travel controller 101a reduces the rotation speed of the inner wheel to the rotation speed corresponding to the second reduction rate (e.g., a rotation speed decrease of 10%), thus performing weak one-side braking.

Since step S91 to step S93 and step S95 to step S97 illustrated in FIG. 10I are identical to step S81 to step S83 and step S85 to step S87 in FIG. 10H, descriptions thereof will be omitted here. In step S94 illustrated in FIG. 10I, if the braking actuator 52 is operated (Yes in step S93) and the type of working device 2 connected to the travel vehicle body 11 is a directly attached working device (Yes in step S94), the travel controller 101a controls the electric motor 34 corresponding to the inner wheel to reduce the rotation speed of the inner wheel to the rotation speed corresponding to the first reduction rate (e.g., a rotation speed decrease of 20%) in step S95, thus performing strong one-side braking. In contrast, if the braking actuator 52 is operated (Yes in step S93) but the type of working device 2 is a towed type (No in step S94), the travel controller 101a controls the electric motor 34 corresponding to the inner wheel to reduce the rotation speed of the inner wheel to the rotation speed corresponding to the second reduction rate (e.g., a rotation speed decrease of 10%) in step S96, thus performing weak one-side braking.

In the case of No in step S92 or in the case of No in step S93, the travel controller 101a does not stop or reduce the rotation speed of the inner wheel in step S97. In other words, if the steering angle is not larger than or equal to the predetermined angle or if the braking actuator 52 is not operated, the travel controller 101a determines that the operation on the one-side braking command actuator 57 is ineffective, and does not perform one-side braking.

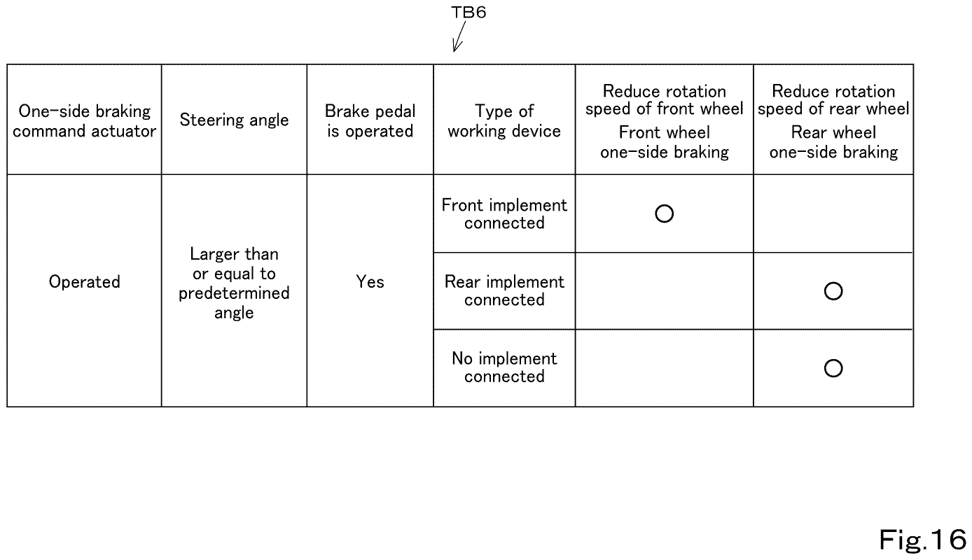

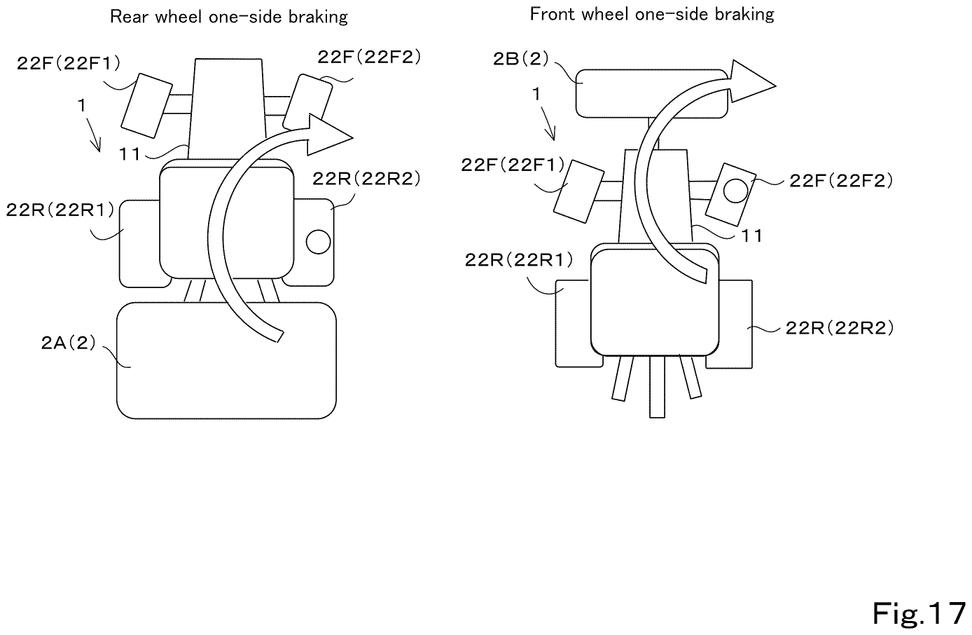

Next, a tenth example of the travel control process will be described with reference to FIG. 10J, FIG. 16, and FIG. 17. FIG. 10J is a flowchart illustrating the tenth example of the travel control process. FIG. 16 illustrates a sixth determination table TB6. FIG. 17 is a plan view schematically illustrating rear-wheel one-side braking and front-wheel one-side braking. For example, as illustrated in FIG. 16, the storing device 102 stores the sixth determination table TB6 that has the execution details of one-side braking set therein. The sixth determination table TB6 has stored therein that front-wheel one-side braking is to be performed if the one-side braking command actuator 57 is operated, the steering angle of the steering actuator 42 is larger than or equal to a predetermined angle, the braking actuator 52 is operated (is pressed), and the type of working device 2 connected to the travel vehicle body 11 is the front working device 2B (front implement), and that rear-wheel one-side braking is to be performed if the type of working device 2 is the rear working device 2A (rear implement) or if the working device 2 is not attached.

When the one-side braking command actuator 57 is operated, the travel controller 101a controls the electric motor 34 corresponding to the front inner wheel to stop or reduce the rotation speed of the front inner wheel if the braking actuator 52 is operated and the working device 2 is connected to the front of the travel vehicle body 11, and controls the electric motor 34 corresponding to the rear inner wheel to stop or reduce the rotation speed of the rear inner wheel if the working device 2 is connected to the rear of the travel vehicle body 11 or if the working device 2 is not connected to the travel vehicle body 11.

The travel controller 101a uses the sixth determination table TB6 illustrated in FIG. 16 to determine the execution details of one-side braking. If the one-side braking command actuator 57 is operated, the steering angle of the steering actuator 42 is larger than or equal to the predetermined angle (turn start angle), the braking actuator 52 is operated, and the type of working device 2 is the front working device 2B (front implement), as illustrated at the right side of FIG. 17, the travel controller 101a performs front-wheel one-side braking. In contrast, if the type of working device 2 is the rear working device 2A (rear implement), as illustrated at the left side of FIG. 17, or if the working device 2 is not attached, the travel controller 101a performs rear-wheel one-side braking.

Since step S101 to step S103 and step S107 illustrated in FIG. 10J are identical to step S91 to step S93 and step S97 in FIG. 10I, descriptions thereof will be omitted. In step S104 illustrated in FIG. 10J, if the braking actuator 52 is operated (Yes in step S103) and the type of working device 2 connected to the travel vehicle body 11 is the front working device 2B (front implement) (Yes in step S104), the travel controller 101a controls the electric motor 34 corresponding to the front inner wheel to stop or reduce the rotation speed of the front inner wheel in step S105. In contrast, if the braking actuator 52 is operated (Yes in step S103) but the type of working device 2 is the rear working device 2A (rear implement) or the working device 2 is not attached (No in step S104), the travel controller 101a controls the electric motor 34 corresponding to the rear inner wheel to stop or reduce the rotation speed of the rear inner wheel in step S106.

In the case of No in step S102 or in the case of No in step S103, the travel controller 101a does not stop or reduce the rotation speed of the inner wheel in step S107. In other words, if the steering angle is not larger than or equal to the predetermined angle or if the braking actuator 52 is not operated, the travel controller 101a determines that the operation on the one-side braking command actuator 57 is ineffective, and does not perform one-side braking.

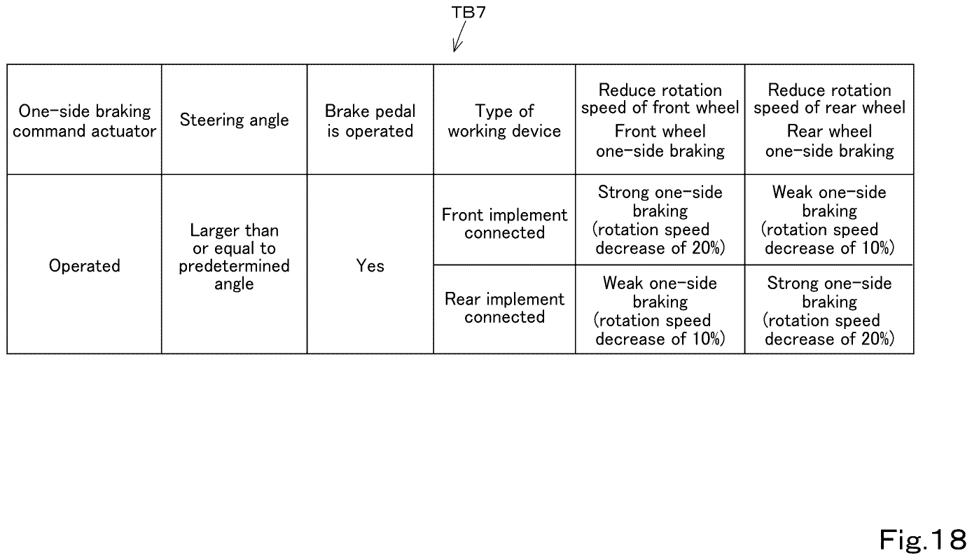

FIG. 10J described above may be replaced by FIG. 10K, and the above-described sixth determination table TB6 illustrated in FIG. 16 may be replaced by a seventh determination table TB7 illustrated in FIG. 18. FIG. 10K is a flowchart illustrating an eleventh example of the travel control process performed by the travel controller 101a. FIG. 18 illustrates the seventh determination table TB7.

As illustrated in FIG. 18, the seventh determination table TB7 has stored therein that front-wheel one-side braking is set to strong one-side braking and rear-wheel one-side braking is set to weak one-side braking if the one-side braking command actuator 57 is operated, the steering angle of the steering actuator 42 is larger than or equal to a predetermined angle, the braking actuator 52 is operated (is pressed), and the type of working device 2 connected to the travel vehicle body 11 is the front working device 2B (front implement), and that rear-wheel one-side braking is set to strong one-side braking and front-wheel one-side braking is set to weak one-side braking if the type of working device 2 connected to the travel vehicle body 11 is the rear working device 2A (rear implement).

If the working device 2 is connected to the front of the travel vehicle body 11, the travel controller 101a reduces the rotation speed of the front inner wheel to the rotation speed corresponding to the first reduction rate (e.g., a rotation speed decrease of 20%), and reduces the rotation speed of the rear inner wheel to the rotation speed corresponding to the second reduction rate (e.g., a rotation speed decrease of 10%) lower than the first reduction rate.

If the working device 2 is connected to the rear of the travel vehicle body 11 or if the working device 2 is not connected to the travel vehicle body 11, the travel controller 101a reduces the rotation speed of the rear inner wheel to the rotation speed corresponding to the first reduction rate (e.g., a rotation speed decrease of 20%), and reduces the rotation speed of the front inner wheel to the rotation speed corresponding to the second reduction rate (e.g., a rotation speed decrease of 10%) lower than the first reduction rate.

Since step S111 to step S114 and step S117 illustrated in FIG. 10K are identical to step S101 to step S104 and step S107 in FIG. 10J, descriptions thereof will be omitted here. In step S114 illustrated in FIG. 10K, if the braking actuator 52 is operated (Yes in step S113) and the type of working device 2 connected to the travel vehicle body 11 is the front working device 2B (front implement) (Yes in step S114), the travel controller 101a controls the electric motor 34 corresponding to the front inner wheel to reduce the rotation speed of the front inner wheel to the rotation speed corresponding to the first reduction rate (e.g., a rotation speed decrease of 20%) and to reduce the rotation speed of the rear inner wheel to the rotation speed corresponding to the second reduction rate (e.g., a rotation speed decrease of 10%) lower than the first reduction rate in step S115.

In contrast, if the braking actuator 52 is operated (Yes in step S113) but the type of working device 2 is the rear working device 2A (rear implement) or the working device 2 is not connected (No in step S114), the travel controller 101a controls the electric motor 34 corresponding to the rear inner wheel to reduce the rotation speed of the rear inner wheel to the rotation speed corresponding to the first reduction rate (e.g., a rotation speed decrease of 20%) and to reduce the rotation speed of the front inner wheel to the rotation speed corresponding to the second reduction rate (e.g., a rotation speed decrease of 10%) lower than the first reduction rate in step S116.

In the case of No in step S112 or in the case of No in step S113, the travel controller 101a does not stop or reduce the rotation speed of the inner wheel in step S117. In other words, if the steering angle is not larger than or equal to the predetermined angle or if the braking actuator 52 is not operated, the travel controller 101a determines that the operation on the one-side braking command actuator 57 is ineffective, and does not perform one-side braking.

Main characteristic items of and effects achieved by the working vehicle 1 according to the above example embodiments and/or the like are as follows.

(Item A1) A working vehicle 1 including a travel vehicle body 11, a power system 31 including one or more electric motors 34 to drive one or more wheels 22 at a left side of the travel vehicle body 11 and one or more wheels 22 at a right side of the travel vehicle body 11, a braking actuator 52, a one-side braking command actuator 57, a steering system 41 to steer the travel vehicle body 11 based on an operation of a steering actuator 42, and a travel controller 101a, wherein the travel controller 101a is configured or programmed to, when the one-side braking command actuator 57 is operated, control, based on whether or not the braking actuator 52 is being operated, one or more of the one or more electric motors 34 that correspond to one or more inner wheels that are the one or more wheels at an inner side of a turn made by the travel vehicle body 11 steered by the steering actuator 42 to stop or reduce a rotation speed of the one or more inner wheels.

With this configuration, whether or not one-side braking is to be performed can be properly determined based on whether or not the braking actuator 52 is being operated when the one-side braking command actuator 57 is operated. If the braking actuator 52 is being operated when the one-side braking command actuator 57 is operated, the rotation speed of the inner wheel(s) at the inner side of the turn made by the travel vehicle body steered by the steering actuator 42 is stopped or reduced, so that one-side-braking can be properly performed. Thus, whether or not one-side braking is to be performed can be properly determined, and one-side braking can be properly performed.

(Item A2) The working vehicle 1 according to item A1, wherein the travel controller 101a is configured or programmed to, when the one-side braking command actuator 57 is operated, perform control to stop or reduce the rotation speed of the one or more inner wheels when the braking actuator 52 is being operated, and not perform the control to stop or reduce the rotation speed of the one or more inner wheels when the braking actuator 52 is not being operated.

With this configuration, as illustrated in FIG. 10A, when the one-side braking command actuator 57 is operated, one-side braking is performed if the braking actuator 52 is being operated, and one-side braking is not performed if the braking actuator 52 is not being operated. Thus, it is possible to determine that the operation on the one-side braking command actuator 57 is an accidental operation when the braking actuator 52 is not being operated. This can prevent one-side braking in response to an accidental operation.

(Item A3) The working vehicle 1 according to item A1, wherein the travel controller 101a is configured or programmed to, when the one-side braking command actuator 57 is operated, reduce the rotation speed of the one or more inner wheels to a rotation speed corresponding to a first reduction rate when the braking actuator 52 is being operated, and reduce the rotation speed of the one or more inner wheels to a rotation speed corresponding to a second reduction rate smaller than the first reduction rate when the braking actuator 52 is not being operated.

With this configuration, as illustrated in FIG. 10B, when the one-side braking command actuator 57 is operated, the rotation speed of the inner wheel(s) is reduced to the rotation speed corresponding to the first reduction rate if the braking actuator 52 is being operated, thus enabling strong one-side braking. In contrast, if the braking actuator 52 is not being operated, the rotation speed of the inner wheel(s) is reduced to the rotation speed corresponding to the second reduction rate smaller than the first reduction rate, thus enabling weak one-side braking. Thus, when the one-side braking command actuator 57 is operated, one-side braking can be performed, making it possible to appropriately perform strong one-side braking and weak one-side braking.

(Item A4) The working vehicle 1 according to item A1 or A3, wherein the travel controller 101a is configured or programmed to, when the one-side braking command actuator 57 is operated, control the rotation speed of the one or more inner wheels at zero or a negative value when an operation amount of the braking actuator 52 is equal to or greater than a predetermined value.

With this configuration, as illustrated in FIG. 10C, when the one-side braking command actuator 57 is operated, if the operation amount of the braking actuator 52 is larger than or equal to the predetermined value, the travel controller 101a controls the rotation speed of the inner wheel(s) to zero or a negative rotation speed, thus allowing the travel vehicle body 11 to make a pivot turn or a spin turn.

(Item A5) The working vehicle 1 according to item A4, wherein the travel controller 101a is configured or programmed to, when the one-side braking command actuator 57 is operated, control the rotation speed of the one or more inner wheels at a zero or a negative value when the following condition is satisfied: the operation amount of the braking actuator 52 is equal to or greater than the predetermined value; and a speed of the travel vehicle body 11 is equal to or less than a predetermined speed.

With this configuration, as illustrated in FIG. 10D, when the one-side braking command actuator 57 is operated, if the operation amount of the braking actuator 52 is greater than or equal to the predetermined value and the speed of the travel vehicle body 11 is less than or equal to the predetermined speed, the travel controller 101a controls the rotation speed of the inner wheel(s) to zero or a negative rotation speed, thus allowing the travel vehicle body 11 to properly perform a pivot turn or a spin turn. In other words, a pivot turn or a spin turn can be prevented from being performed in a state where the speed of the travel vehicle body 11 exceeds the predetermined speed.

(Item A6) The working vehicle 1 according to item A4, wherein the travel controller 101a is configured or programmed to prohibit control of the rotation speed of the one or more inner wheels at zero or a negative value in a case that a working device 2 connected to the travel vehicle body 11 is a towed working device.

With this configuration, as illustrated in FIG. 10E, the travel vehicle body 11 having the working device 2 (implement) which is a towed working device connected thereto can be prevented from making a pivot turn or a spin turn.

(Item A7) The working vehicle 1 according to item A4, wherein the travel controller 101a is configured or programmed to control the rotation speed of the one or more inner wheels at zero or a negative value in a case that a weight of a working device 2 connected to the travel vehicle body 11 is equal to or less than a predetermined weight.

With this configuration, as illustrated in FIG. 10F, if the weight of the working device 2 (implement) connected to the travel vehicle body 11 is smaller than or equal to the predetermined weight, the travel vehicle body 11 makes a pivot turn and a spin turn, thus preventing an agricultural field from being damaged by each turn. In other words, since an agricultural field is damaged as a result of a pivot turn or a spin turn made by the travel vehicle body 11 having connected thereto the working device 2 weighing above the predetermined weight, such a situation can be prevented.

(Item A8) The working vehicle 1 according to item A4, wherein the travel controller 101a is configured or programmed to control the rotation speed of the one or more inner wheels at zero or a negative value in a case that a tilt angle of the travel vehicle body 11 is equal to or less than a predetermined tilt angle.

With this configuration, as illustrated in FIG. 10G, if the tilt angle of the travel vehicle body 11 is smaller than or equal to the predetermined tilt angle, the rotation speed of the inner wheel(s) is controlled at zero or a negative rotation speed, thus allowing the travel vehicle body 11 to properly make a pivot turn or a spin turn.

(Item A9) The working vehicle 1 according to item A1, wherein the travel controller 101a is configured or programmed to, when the one-side braking command actuator 57 is operated, reduce the rotation speed of the one or more inner wheels to a rotation speed corresponding to a first reduction rate in a case that the braking actuator 52 is being operated and no working devices 2 are connected to the travel vehicle body 11, and reduce the rotation speed of the one or more inner wheels to a rotation speed corresponding to a second reduction rate smaller than the first reduction rate in a case that a working device 2 is connected to the travel vehicle body 11.

With this configuration, as illustrated in FIG. 10H, when the one-side braking command actuator 57 is operated, the travel controller 101a reduces the rotation speed of the inner wheel(s) to the rotation speed corresponding to the first reduction rate to enable strong one-side braking if the braking actuator 52 is being operated and no working devices 2 (implements) are connected, and reduces the rotation speed of the inner wheel(s) to the rotation speed corresponding to the second reduction rate smaller than the first reduction rate to enable weak one-side braking if a working device 2 is connected. This enables strong one-side braking when no working devices 2 are connected and enables weak one-side braking when the working device 2 is connected. Thus, this enables appropriate one-side braking depending on whether the working device 2 is connected or not connected.

(Item A10) The working vehicle 1 according to item A1, wherein the travel controller 101a is configured or programmed to, when the one-side braking command actuator 57 is operated, reduce the rotation speed of the one or more inner wheels to a rotation speed corresponding to a first reduction rate in a case that the braking actuator 52 is being operated and a working device 2 connected to the travel vehicle body 11 is a directly attached working device, and reduce the rotation speed of the one or more inner wheels to a rotation speed corresponding to a second reduction rate smaller than the first reduction rate in a case that the working device 2 is a towed working device.

With this configuration, as illustrated in FIG. 10I, when the one-side braking command actuator 57 is operated, the travel controller 101a reduces the rotation speed of the inner wheel(s) to the rotation speed corresponding to the first reduction rate to enable strong one-side braking if the braking actuator 52 is being operated and the working device 2 (implement) connected to the travel vehicle body 11 is of a directly attached working device, and reduces the rotation speed of the inner wheels(s) to the rotation speed corresponding to the second reduction rate smaller than the first reduction rate to enable weak one-side braking if the working device 2 isa towed working device (e.g., a trailer). This enables strong one-side braking when the working device 2 is a directly attached working device and enables weak one-side braking when the working device 2 is a towed working device (trailer). Thus, this enables appropriate one-side braking depending on whether the working device 2 is a directly attached working device or a towed working device (trailer).

(Item A11) The working vehicle 1 according to item A1, wherein the travel controller 101a is configured or programmed to, when the one-side braking command actuator 57 is operated, control one of the one or more electric motors 34 that corresponds to a front one of the one or more inner wheels to stop or reduce the rotation speed of the front one of the one or more inner wheels in a case that the braking actuator 52 is being operated and a working device 2 is connected to a front portion of the travel vehicle body 11, and control one of the one or more electric motors 34 that corresponds to a rear one of the one or more inner wheels to stop or reduce the rotation speed of the rear one of the one or more inner wheels in a case that the working device 2 is connected to a rear portion of the travel vehicle body 11 or no working devices 2 are connected to the travel vehicle body 11.

With this configuration, as illustrated in FIG. 10J, when the one-side braking command actuator 57 is operated, if the braking actuator 52 is being operated and the working device 2 is connected to the front of the travel vehicle body 11, since the center of gravity of the travel vehicle body 11 including the working device 2 at the front is located at the front, the travel controller 101a stops or reduces the rotation speed of the front inner wheel, as illustrated at the right side of FIG. 17. If the working device 2 is connected to the rear portion of the travel vehicle body 11 or no working devices 2 are connected, since the center of gravity of the travel vehicle body 11 including the working device 2 at the rear is located at the rear or the center of gravity of the travel vehicle body 11 not having the working device 2 connected thereto is located at the rear, the travel controller 101a stops or reduces the rotation speed of the rear inner wheel, as illustrated at the left side of FIG. 17. Thus, even when the center of gravity of the entire travel vehicle body 11 is shifted forward or rearward due to the working device 2 being connected to the front or rear, one-side braking can be properly performed.

(Item A12) The working vehicle 1 according to item A11, wherein the travel controller 101a is configured or programmed to, in a case that the working device 2 is connected to the front portion of the travel vehicle body 11, reduce the rotation speed of the front one of the one or more inner wheels to a rotation speed corresponding to a first reduction rate, and reduce the rotation speed of the rear one of the one or more inner wheels to a rotation speed corresponding to a second reduction rate smaller than the first reduction rate.

With this configuration, as illustrated in FIG. 10K, if the working device 2 is connected to the front of the travel vehicle body 11, the rotation speed of the front inner wheel is reduced to the rotation speed corresponding to the first reduction rate to enable strong one-side braking, and the rotation speed of the rear inner wheel is reduced to the rotation speed corresponding to the second reduction rate lower than the first reduction rate to enable weak one-side braking. In other words, in the case of a front implement, the center of gravity of the travel vehicle body 11 is located at the front, so that strong one-side braking can be applied to the front inner wheel located closer to the center of gravity and weak one-side braking can be applied to the rear inner wheel. Thus, in the case of a front implement, a spin can be performed using the front inner wheel located closer to the center of gravity of the travel vehicle body 11 as a turning center.

(Item A13) The working vehicle 1 according to item A11, wherein the travel controller 101a is configured or programmed to, in a case that the working device 2 is connected to the rear portion of the travel vehicle body 11 or no working devices 2 are connected to the travel vehicle body 11, reduce the rotation speed of the rear one of the one or more inner wheels to a rotation speed corresponding to a first reduction rate, and reduce the rotation speed of the front one of the one or more inner wheels to a rotation speed corresponding to a second reduction rate smaller than the first reduction rate.

With this configuration, as illustrated in FIG. 10K, if the working device 2 is connected to the rear of the travel vehicle body 11 or if no working devices 2 are connected to the travel vehicle body 11, the rotation speed of the rear inner wheel is reduced to the rotation speed corresponding to the first reduction rate to enable strong one-side braking, and the rotation speed of the front inner wheel is reduced to the rotation speed corresponding to the second reduction rate smaller than the first reduction rate to enable weak one-side braking. In other words, in the case of a rear implement or no implement, since the center of gravity of the travel vehicle body 11 is located toward the rear, strong one-side braking can be applied to the rear inner wheel located closer to the center of gravity and weak one-side braking can be applied to the front inner wheel. Thus, in the case of a rear implement or no implement, a spin can be performed using the rear inner wheel located closer to the center of gravity of the travel vehicle body 11 as a turning center.

(Item A14) The working vehicle 1 according to any one of items A1 to A13, wherein the braking actuator 52 is a single actuator.

With this configuration, in the working vehicle 1 including a single braking actuator 52, i.e., in a configuration different from a working vehicle in the related art that includes a two-piece brake pedal (i.e., a left brake pedal and a right brake pedal) to brake left and right wheels independently of each other, one-side braking can be properly performed.

(Item A15) A working vehicle 1 including a travel vehicle body 11, a power system 31 including one or more electric motors 34 to drive one or more wheels 22 at a left side of the travel vehicle body 11 and one or more wheels 22 at a right side of the travel vehicle body 11, a steering system 41 to steer the travel vehicle body 11 based on an operation of a steering actuator 42, an input interface 57A to receive an input of an operation to stop or reduce a rotation speed of one or more inner wheels which are the one or more wheels at an inner side of a turn made by the travel vehicle body 11 steered by the steering actuator 42, and a travel controller 101a, wherein the travel controller 101a is configured or programmed to, when the input interface 57A receives input of the operation while the one or more wheels at the left side and the one or more wheels at the right side are both receiving a braking force applied by braking operation, control one or more of the one or more electric motors 34 that correspond to the one or more inner wheels to stop or reduce the rotation speed of the one or more inner wheels.

With this configuration, it is possible to properly determine whether or not one-side braking is to be performed based on an operation of the input interface 57A when wheels at both sides are in a braked state during steering. If there is an operation of the input interface 57A when wheels at both sides are in a braked state during steering, the inner wheel(s) (wheel(s) at the inner side of the turn made by the travel vehicle body steered by the steering actuator 42) can be braked even stronger. In other words, one-side braking can be properly performed. Thus, it is possible to properly determine whether or not one-side braking is to be performed, and one-side braking can be properly performed.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a travel vehicle body;
a power system including one or more electric motors to drive one or more wheels at a left side of the travel vehicle body and one or more wheels at a right side of the travel vehicle body;
a braking actuator;
a one-side braking command actuator;
a steering system to steer the travel vehicle body based on an operation of a steering actuator; and
a travel controller; wherein
the travel controller is configured or programmed to, when the one-side braking command actuator is operated, control, based on whether or not the braking actuator is being operated, one or more of the one or more electric motors that correspond to one or more inner wheels that are the one or more wheels at an inner side of a turn made by the travel vehicle body steered by the steering actuator to stop or reduce a rotation speed of the one or more inner wheels.

2. The working vehicle according to claim 1, wherein the travel controller is configured or programmed to, when the one-side braking command actuator is operated:
perform control to stop or reduce the rotation speed of the one or more inner wheels when the braking actuator is being operated; and
not perform the control to stop or reduce the rotation speed of the one or more inner wheels when the braking actuator is not being operated.

3. The working vehicle according to claim 1, wherein the travel controller is configured or programmed to, when the one-side braking command actuator is operated:
reduce the rotation speed of the one or more inner wheels to a rotation speed corresponding to a first reduction rate when the braking actuator is being operated; and
reduce the rotation speed of the one or more inner wheels to a rotation speed corresponding to a second reduction rate smaller than the first reduction rate when the braking actuator is not being operated.

4. The working vehicle according to claim 1, wherein the travel controller is configured or programmed to, when the one-side braking command actuator is operated, control the rotation speed of the one or more inner wheels at zero or a negative value when an operation amount of the braking actuator is equal to or greater than a predetermined value.

5. The working vehicle according to claim 4, wherein the travel controller is configured or programmed to, when the one-side braking command actuator is operated, control the rotation speed of the one or more inner wheels at a zero or a negative value when the following condition is satisfied:
the operation amount of the braking actuator is equal to or greater than the predetermined value; and
a speed of the travel vehicle body is equal to or less than a predetermined speed.

6. The working vehicle according to claim 4, wherein the travel controller is configured or programmed to prohibit control of the rotation speed of the one or more inner wheels at zero or a negative value in a case that a working device connected to the travel vehicle body is a towed working device.

7. The working vehicle according to claim 4, wherein the travel controller is configured or programmed to control the rotation speed of the one or more inner wheels at zero or a negative value in a case that a weight of a working device connected to the travel vehicle body is equal to or less than a predetermined weight.

8. The working vehicle according to claim 4, wherein the travel controller is configured or programmed to control the rotation speed of the one or more inner wheels at zero or a negative value in a case that a tilt angle of the travel vehicle body is equal to or less than a predetermined tilt angle.

9. The working vehicle according to claim 1, wherein the travel controller is configured or programmed to, when the one-side braking command actuator is operated:
reduce the rotation speed of the one or more inner wheels to a rotation speed corresponding to a first reduction rate in a case that the braking actuator is being operated and no working devices are connected to the travel vehicle body; and
reduce the rotation speed of the one or more inner wheels to a rotation speed corresponding to a second reduction rate smaller than the first reduction rate in a case that a working device is connected to the travel vehicle body.

10. The working vehicle according to claim 1, wherein the travel controller is configured or programmed to, when the one-side braking command actuator is operated:
reduce the rotation speed of the one or more inner wheels to a rotation speed corresponding to a first reduction rate in a case that the braking actuator is being operated and a working device connected to the travel vehicle body is a directly attached working device; and
reduce the rotation speed of the one or more inner wheels to a rotation speed corresponding to a second reduction rate smaller than the first reduction rate in a case that the working device is a towed working device.

11. The working vehicle according to claim 1, wherein the travel controller is configured or programmed to, when the one-side braking command actuator is operated:
control one of the one or more electric motors that corresponds to a front one of the one or more inner wheels to stop or reduce the rotation speed of the front one of the one or more inner wheels in a case that the braking actuator is being operated and a working device is connected to a front portion of the travel vehicle body; and
control one of the one or more electric motors that corresponds to a rear one of the one or more inner wheels to stop or reduce the rotation speed of the rear one of the one or more inner wheels in a case that the working device is connected to a rear portion of the travel vehicle body or no working devices are connected to the travel vehicle body.

12. The working vehicle according to claim 11, wherein the travel controller is configured or programmed to, in a case that the working device is connected to the front portion of the travel vehicle body:
reduce the rotation speed of the front one of the one or more inner wheels to a rotation speed corresponding to a first reduction rate; and
reduce the rotation speed of the rear one of the one or more inner wheels to a rotation speed corresponding to a second reduction rate smaller than the first reduction rate.

13. The working vehicle according to claim 11, wherein the travel controller is configured or programmed to, in a case that the working device is connected to the rear portion of the travel vehicle body or no working devices are connected to the travel vehicle body:
reduce the rotation speed of the rear one of the one or more inner wheels to a rotation speed corresponding to a first reduction rate; and
reduce the rotation speed of the front one of the one or more inner wheels to a rotation speed corresponding to a second reduction rate smaller than the first reduction rate.

14. The working vehicle according to claim 1, wherein the braking actuator is a single actuator.

15. A working vehicle comprising:
a travel vehicle body;
a power system including one or more electric motors to drive one or more wheels at a left side of the travel vehicle body and one or more wheels at a right side of the travel vehicle body;
a steering system to steer the travel vehicle body based on an operation of a steering actuator;
an input interface to receive an input of an operation to stop or reduce a rotation speed of one or more inner wheels that are the one or more wheels at an inner side of a turn made by the travel vehicle body steered by the steering actuator; and
a travel controller; wherein
the travel controller is configured or programmed to, when the input interface receives input of the operation while the one or more wheels at the left side and the one or more wheels at the right side are both receiving a braking force applied by braking operation, control one or more of the one or more electric motors that correspond to the one or more inner wheels to stop or reduce the rotation speed of the one or more inner wheels.
